(19) United States
(12) Patent Application Publication
(10) Pub. No.: US 2013/0010100 A1
(43) Pub. Date: Jan. 10, 2013

(54) IMAGE GENERATING METHOD AND DEVICE USING SCANNING CHARGED PARTICLE MICROSCOPE, SAMPLE OBSERVATION METHOD, AND OBSERVING DEVICE

(76) Inventors: Go Kotaki, Kumamoto (JP); Atsushi Miyamoto, Yokohama (JP); Kenji Nakahira, Fujisawa (JP); Takashi Hiroi, Yokohama (JP)

(21) Appl. No.: 13/522,557

(22) PCT Filed: Mar. 4, 2011
(86) PCT No.: PCT/JP2011/001275

§ 371 Date: Sep. 25, 2012

(30) Foreign Application Priority Data
Mar. 18, 2010 (JP) 2010-061777

(51) Int. Cl. H04N 7/18

(52) U.S. Cl. 348/80; 348/E07.085

(57) ABSTRACT

In a process of acquiring an image of semiconductor patterns by using a scanning electron microscope (SEM), this invention provides an image generating method and device that allows a high-resolution SEM image to be produced while suppressing damages caused by SEM imaging to a sample as a result of irradiation of an electron beam. A plurality of areas having similarly shaped patterns (similar areas) are extracted from a low-resolution SEM image which has been imaged while suppressing the irradiation energy of electron beam. From the image data of the extracted areas a single high resolution image of the patterns is generated by image restoration processing. Further, the method of this invention also uses design data in determining the similar areas and the SEM imaging position and imaging range for performing the image restoration processing.

### TECHNICAL FIELD

The present invention relates to a method of enhancing a resolution of images obtained by a scanning charged particle microscope by image processing.

### BACKGROUND ART

Circuit patterns on a semiconductor wafer are formed by applying a photosensitive material, called a photoresist, to the wafer, exposing the pattern on a photomask onto the wafer using a projection aligner and developing the exposed pattern. In forming finely structured circuit patterns in a semiconductor wafer, inspections play an important role. The inspections used include a shape inspection to check whether the dimensions and shape of the formed patterns conform to a design specification of device characteristics and a defect inspection to check for such defects as pattern shorts, chipping and particles that may lead to possible device failures. Used in these inspections are scanning electron microscopes (SEM), one of the scanning charged particle microscopes.

The shape inspection is performed on a semiconductor circuit pattern by processing an image of the pattern shot by a SEM to measure the dimension of the pattern or by comparing a two-dimensional pattern outline extracted from the image with design data. Based on the result of the shape inspection, a semiconductor device manufacturing equipment is adjusted to be able to form good circuit patterns on semiconductor wafers. As semiconductor circuit patterns have become more and more miniaturized, a diffraction phenomenon of light during exposure has come be observed to affect the formation of patterns. To cope with this problem, a technology is available that adds an auxiliary pattern, called OPC (Optical Proximity Correction), to a photomask pattern for offsetting the influence of the light diffraction phenomenon, thereby forming satisfactory circuit patterns on the wafers.

The defect inspection on the other hand checks for defects on the semiconductor circuit pattern by comparing an inspection image taken by a SEM with a reference image that has a similar appearance of the pattern to that of the inspection image but does not include any defects. As a reference image, the inspection images of a chip or cells shot by shifting a viewing position or angle may be used. In the case of a repetitive pattern, such as memory cells, it is possible to synthesize a reference image corresponding to an inspection image from image data of one cell. There is also a case where a check is made not only of the presence or absence of defects but also of their kind and size. The defect inspection allows for determining if semiconductor devices have passed or failed the inspection and for analyzing causes of defects that would otherwise lead to failures of semiconductor devices.

As semiconductor devices are having increasingly miniaturized circuit patterns, there is a growing need for highly precise inspections on pattern shape and minute defects, making it increasingly important to obtain high resolution images.

Conventional techniques for producing high resolution images by SEM include:

(1) one that improves the resolution on the part of design of an imaging electro-optical system by increasing an acceleration voltage to throttle an electron beam diameter; and (2) one that improves the resolution by imaging a circuit pattern at one location multiple times by shifting the imaging position a very small distance at a time to produce a plurality of SEM images and then performing image restoration processing on these multiple SEM images to turn them into a single high resolution image (Patent Literature 1)

### CITATION LIST

Patent Literature 1: JP-A-2006-139965

### SUMMARY OF INVENTION

### Technical Problem

As to the aforementioned conventional technique (1), although throttling the electron beam diameter by increasing the acceleration voltage can produce a high resolution image, this method poses a problem that intensified electron beams make greater damages to the semiconductor wafer, deforming the pattern. The pattern deformations are known to include such phenomena as a pattern shrink in which the pattern shrinks as it is bombarded by electron beams and a contamination in which the pattern is made thick by contaminants adhering to the wafer. The finer the pattern gets, the greater the effect that the pattern deformation has on the device characteristics, thus making the problem more serious. Lowering the acceleration voltage increases diffraction aberration and lens aberration, resulting in the resolution being degraded. As described above, as to the technique to improve the resolution by the design of an electro-optical system, there is a tradeoff between the resolution and the damage the electron beams does to samples. This means that it is difficult to achieve the resolution improvement and the minimization of damages to the sample at the same time.

As for the aforementioned conventional technique (2), to obtain an image with a sufficient resolution for the image restoration processing requires inputting many images containing similarly shaped patterns (similar images) into the image restoration processing. Considering the possible damages to the sample, however, there is a limit on the number of images that can be taken, which in turn reduces the number of similar images to be input into the image restoration processing, making it difficult to produce images with a high enough resolution.

The object of the present invention is to solve the aforementioned problems and to provide an image generating method and its device and a sample observation method and its device that produce images with a high resolution while minimizing damages that electron beams cause to samples during an image taking procedure using a scanning charged particle microscope. Other objects and novel features of this invention will become apparent from the description of this specification and appended drawings.

### Solution to Problem

To solve the aforementioned problem, the present invention provides a scanning charged particle microscope with the following features and a method of acquiring a high resolution image of semiconductor patterns by using the scanning charged particle microscope. Although in the following description, a scanning electron microscope (SEM) is taken up as an example, it is noted, however, that the invention is not limited to this type of microscope but can also be applied to other scanning charged particle microscopes, such as a scanning ion microscope (SIM) and a scanning transmission electron microscope (STEM).

(1) This invention is characterized by a process that involves imaging and acquiring an image of semiconductor circuit patterns using a SEM, extracting a plurality of areas having similarly shaped patterns from the image, and executing image restoration processing by using images of the plurality of the extracted areas. This allows many images of the similarly shaped patterns to be fed into the image restoration processing, thus producing a resolution-enhanced pattern image.

In executing the image restoration processing, however, there are cases where it is difficult to extract areas having similarly shaped patterns from the SEM image. In images of memory cells that have cyclically repetitive patterns, for example, areas having similarly shaped patterns can easily be extracted by using information on a pattern period. But in images of logic circuits that locally include distinctive patterns or non-cyclic repetitive patterns, the use of the pattern period information-based method cannot extract areas having similarly shaped patterns.

To solve this problem, this invention includes as one of its features a process of identifying in the input image an area that has two or more of similarly shaped patterns that are applicable to the image restoration processing (similar pattern categorized region) and an area without them (non-similar pattern categorized region) and performing the image restoration processing on the similar pattern categorized region. With this process, even if the image includes non-similar or distinctive patterns, the image restoration processing can be executed by avoiding these patterns.

Another feature of this invention is that, after a group of areas that are to be subjected to the image restoration processing is picked up from the similar pattern categorized region (a similar area group), the image restoration processing is performed on a group of images of the similar areas (a group of similar images). The group of similar areas is so determined that every similar area in the group includes a common similar pattern. The image restoration processing can produce an image with a higher resolution as the number of similar images to be processed and the similarity levels between the similar images increase. With the above procedure, the image restoration processing can be performed not only on an image of simple, periodically repetitive patterns as in a memory cell but also on an image that includes complex patterns as in a logic circuit as long as it has two or more patterns partly similar to one another, thereby enhancing the resolution of the pattern image.

However, in extracting a group of similar areas from the similar pattern categorized region, the position and size of a unit area that is used to extract similar areas are, in the first place, difficult to determine. So, to extract a group of similar areas, this invention sets an area that serves as a reference in searching the similar areas (reference area) and then performs pattern matching between the reference area and the similar pattern categorized region. In this process, the reference area and a group of similar areas are determined in a way that renders the number of similar areas and the similarity levels between the similar areas as high as possible. That is, this invention is characterized in that the reference area is optimized by using the size and position of the reference area representing the number of similar areas in the group and the similarity levels between images of the similar areas as an index value so that the image restoration processing can be performed as intended.

Further, the invention is characterized in that a resolution-enhanced image generated by the image restoration processing is displayed on a GUI. It is also characterized in that pattern dimensions are measured or pattern outlines are extracted by performing image processing on the resolution-enhanced image produced by the image restoration processing. For a sample with low resistance against electron beams, such as ArF resist, this characteristic procedure allows the images of line patterns and hole patterns, that have been imaged with low magnifications to minimize damages the electron beam irradiation causes to the sample, to be enhanced in resolution by the image restoration processing. That is, highly precise dimension measurements and outline extraction are rendered possible.

(2) In the image restoration processing as described in the above item (1), the greater the number of similarly shaped pattern images fed into the processing, the more enhanced the resolution of a processed image can be. Generally, semiconductor circuit patterns contain many laterally or vertically symmetric patterns. So, in evaluating a similarity level between images of two similar areas in the input SEM image, the invention sets high an index value representing the similarity level between the two similar area images if one of the images, after being rotated or inverted, is found to resemble the other similar area image.

In the process of imaging circuit patterns by the SEM, a photographed image may be partially distorted by a sample becoming electrically charged by electron beam. Even in such a case, however, the distorted image may be able to be used for the image restoration processing if the distortions are corrected by image processing. So, in this invention the level of shape similarity is evaluated by allowing some pattern distortions in addition to the rotation and inversion. Further, images of similar areas to be used in the image restoration processing (input images of similar areas) are subjected to the rotations, inversions and minute distortions before they undergo the image restoration processing. As described above, evaluating the level of pattern similarity by accommodating some degrees of deformations can increase the number of similar images to be input to the image restoration processing.

(3) In the image restoration processing, it is desired that not only the number of input similar images but the similarity levels between the input similar images be made as high as possible. However, where the input similar images partly include an image which, though similar in pattern shape to the rest of the images, differs in quality such as brightness, noise and pattern edge signal profile (edge profile), a finally restored image may be affected greatly by that image of different quality. One of the factors contributing to such image quality changes is a scan direction of electron beam used during the SEM imaging. The laterally inverted image that is referred to in the above item (2) has an edge profile close to that of an image which is acquired by inverting the scan direction. For the image restoration processing to be able to operate with high level of robustness even when there are variations in quality between input similar images, the invention calculates for each of the input similar images an index value representing a level of similarity in pattern shape or image quality (similarity index value) and causes a similar image with a higher index value to be reflected to a greater extent on the finally produced resolution-enhanced image.

(4) The invention is also characterized in that an image is produced by pasting the high resolution images to where the similar areas are located (synthesized high resolution image).

That is, although the image restoration processing referred to in the above item (1) generates one high resolution image representing the similar areas from a group of images of the similar areas, the high resolution image thus produced does not show the positional relation among the patterns of the similar areas. In the synthesized high resolution image, on the other hand, the positional relation among the patterns of the resolution-enhanced similar areas can easily be known. Further, as for those areas that could not be enhanced in resolution, the input image may be partly enhanced in resolution by pasting the input image or an interpolated and extended input image to those areas. For example, an inspection image can be resolution-enhanced by extracting a defect area through comparison between the inspection image containing the defect and the reference image, resolution-enhancing an area excluding the defect area, and then pasting to the defect area the image of the defect portion taken from the interpolated and extended input image.

Even if patterns in the input image somewhat differ in shape among the similar areas (the condition in which the areas are extracted as similar areas is that their shapes resemble each other to a certain degree), the resulting patterns in all the similar areas in the synthesized high resolution image finally output by the aforementioned method will end up having the same appearances. To deal with this problem, the image restoration processing in this invention is performed by calculating for each of the similar areas the similarity index value described in the above item (3). That is, in generating a high resolution image of an n-th similar area contained in a similar area group (n-th high resolution image) by the image restoration processing, the invention is characterized in that index values representing pattern similarity levels between the n-th similar area and other similar areas in the group (similarity index values) are calculated and that images of similar areas with high similarity index values are reflected more than others on the n-th high resolution image. This enables the entire input image to be enhanced in resolution while keeping features of the pattern shape in the individual similar areas.

A further feature of the invention is that the synthesized high resolution image is displayed on a GUI. The invention is also characterized by the use of image processing on the synthesized high resolution image in measuring pattern dimensions or extracting pattern outlines.

(5) In the above item (1), the invention is characterized by first inputting a pattern of interest and then enhancing the resolution of an image of the area having the pattern of interest. That is, in evaluating the shapes of patterns, there is a case where only a part of the input image needs to be enhanced in resolution. In that case, the resolution enhancement processing can be simplified and increased in speed. More specifically, the division of the input image into a similar pattern categorized region and a non-similar pattern categorized region and the setting of areas to be subjected to the image restoration processing can be eliminated. The invention is also characterized by manually inputting the pattern of interest or inputting a pattern from the neighborhood of a critical location called a hotspot, output by EDA (Electronic Design Automation) tool, where a defect is considered likely to occur. It is also possible to use a pattern located near the central portion of the input image as the pattern of interest because the pattern used for shape evaluation is often imaged so that it rests close to the central part of the input image. The invention is also characterized by further processing the high resolution image produced by the image restoration processing to measure pattern dimensions and extract pattern outlines.

(6) The invention is characterized by a process of setting an imaging position and an imaging range (imaging field of view) of SEM photography, inputting design data of circuit patterns including the imaging field of view and determining a group of similar areas of the above item (1) based on the design data.

With the method of the above item (1), it cannot be known until an input image is photographed whether there is an area in the input image that has similarly shaped patterns (similar areas). Furthermore, in extracting similar areas, if the input image is blurred or has a low resolution or a low S/N, a similar area searching method that is based on image information, such as template matching, may not work at all. To deal with this problem, this invention is characterized in that similar areas are searched offline (no imaging apparatus is required) by using design data. More specifically, this method involves extracting a group of areas containing similarly shaped patterns (similar area group) on the design data, outputting information on the extracted group of similar areas to a file and, after the input image has been photographed, reading the information on the similar area group from the file. With this method the similar area search operation can be separated from the imaging operation. Further, the use of the design data in searching similar areas allows for a robust search highly tolerant of blurs and errors of S/N and quantization.

This invention is also characterized in that the imaging field of view first taken in is re-set by using design data. The re-setting procedure uses the design data of the first input field of view and of the surrounding areas to search for a field of view that contains as many similar areas as possible. This allows the number of similar areas taken into the image restoration processing to be increased. In the image restoration processing, not just the number of similar areas but the similarity level between the images of similar areas, as they go higher, contribute more to the enhancement of the resolution of the processed image. With this fact taken into account, this invention is characterized in that the field of view is determined in a way that puts as many similar areas in the field of view as possible and which increases an index value representing the similarity level between the images of the similar areas to as high a level as possible.

During the similar area extraction process, which is done by checking the similarity level based on design data, there may be discrepancies in shape between actual patterns formed on a wafer (patterns actually used in the image restoration processing) and the corresponding design data patterns. For example, even patters that have the same shapes on the design data may differ in the actual pattern shape, depending on the density of surrounding patterns. There can also be cases where the presence of defects such as particles causes the actual pattern to differ greatly locally in shape from the corresponding design data pattern. To cope with such situations, this invention reevaluates the similarity levels between similar areas, based on the images of the similar areas that have been extracted by using the design data. That is, the reevaluation procedure of the invention involves further dividing each of the similar areas in the group into a plurality of areas (a group of divided areas), sorting the images of the divided areas into similar divided areas and non-similar divided areas (exceptional areas) and removing the exceptional areas from the group of similar areas before executing the image restoration processing. With this process performed, the image restoration processing can be made tolerant of pattern deformations and extraneous substances.

(7) In the aforementioned items (1) and (6), the invention is characterized by acquiring and inputting a plurality of SEM images. That is, similar areas are extracted not from a single image but from a plurality of SEM images to increase the number of similar areas thereby improving the resolution enhancement performance of the image restoration processing. To this end there needs to be a plurality of SEM images that contain similarly shaped patterns. A method of this invention for acquiring such SEM images involves imaging that position on a chip or cell adjoining the first photographed SEM image which has the same relative coordinates as in the first SEM image to acquire a second SEM image. An example to which this method can be effectively applied is a complex mask pattern with OPC. In this complex mask pattern that has few similarly shaped patterns, it is difficult to execute the image restoration processing using a single SEM image. To get around this problem, another SEM image is taken from an adjoining chip or cell that is expected to have the same patterns as those of the first photographed SEM image and the second SEM image is used in the image restoration processing. This process allows the image of complex mask patterns with OPC to be enhanced in resolution.

Another method for acquiring a plurality of SEM images involves storing images acquired so far in an image database linked with the SEM and, if there is any image of a position close to the imaging position of the input image, inputting that image. If design data is available, a plurality of fields of view having many similarly shaped patterns on the design data are determined and photographed to acquire a plurality of SEM images for use in the processing.

Representative aspects of the invention disclosed in this application will be briefly summarized as follows.

(a) A method of observing a sample formed with circuit patterns by using a scanning charged particle microscope, the sample observing method comprising the steps of: acquiring an input image by imaging the circuit patterns using the scanning charged particle microscope; extracting from the acquired single input image a plurality of areas having patterns similar in shape to one another, based on a predetermined decision criterion; generating from images of the plurality of the extracted areas having patterns similar in shape to one another an image higher in resolution than the images of the plurality of the extracted areas; and observing the circuit patterns by using the generated image higher in resolution than the images of the plurality of the extracted areas.

(b) A sample observation method according to (a), wherein the step of extracting a plurality of areas checks indices of how many areas containing patterns similar in shape to one another can be extracted from the single input image and of how much the images of the extractable areas containing similar patterns resemble each other, and extracts the plurality of areas based on the indices.

(c) A device for observing a sample formed with circuit patterns comprising: a scanning charged particle microscope to acquire an input image by imaging the circuit patterns; a means to extract from the acquired single input image a plurality of areas having patterns similar in shape to one another, based on a predetermined decision criterion; a means to generate from images of the plurality of the extracted areas having patterns similar in shape to one another an image higher in resolution than the images of the plurality of the extracted areas; and a means to observe the circuit patterns by using the generated images higher in resolution than the images of the plurality of the extracted areas.

(d) A method for generating an image of semiconductor circuit patterns formed on a sample by using a scanning charged particle microscope, the image generation method comprising: an image input step to take in an image acquired by imaging the semiconductor circuit patterns using the scanning charged particle microscope (input image); a similar region categorizing step to identify in the input image a region having at least two similarly shaped patterns (similar pattern categorized region) and a region with no such patterns (non-similar pattern categorized region); a similar area group determination step to determine in the similar pattern categorized region a group of areas used for image restoration processing (a group of similar areas); and a high resolution image generation step to produce one resolution-enhanced image of similar areas (high resolution image) from the images of the group of similar areas by the image restoration processing; wherein each of the similar areas in the group includes a similarly shaped common pattern; wherein the similar areas are determined based on the number of the similar areas in the group and on an index value (similarity index value) representing the similarity levels between images of the similar areas in the group.

(e) A device for generating an image of semiconductor circuit patterns formed on a sample by using a scanning charged particle microscope, the image generation method comprising: an image input means to take in an image acquired by imaging the semiconductor circuit patterns using the scanning charged particle microscope (input image); a similar region categorizing means to identify in the input image a region having at least two similarly shaped patterns (similar pattern categorized region) and a region with no such patterns (non-similar pattern categorized region); a similar area group determination means to determine in the similar pattern categorized region a group of areas used for image restoration processing (a group of similar areas); and a high resolution image generation means to produce one resolution-enhanced image of similar areas (high resolution image) from the images of the group of similar areas by the image restoration processing; wherein each of the similar areas in the group includes a similarly shaped common pattern; wherein the similar areas are determined based on the number of the similar areas in the group and on an index value (similarity index value) representing the similarity levels between images of the similar areas in the group.

(f) A method for generating an image of semiconductor circuit patterns formed on a sample by using a scanning charged particle microscope, the image generation method comprising: an image input step to take in an image acquired by imaging the semiconductor circuit patterns using the scanning charged particle microscope (input image); a similar area group determination step to determine in the input image a group of areas to be used for image restoration processing (a group of similar areas); a high resolution image generation step to produce a single resolution-enhanced image of a similar area (high resolution image) from images of the group of similar areas by the image restoration processing; and a synthesized high resolution image generation step to produce an image that has the high resolution images of similar areas pasted where the corresponding similar areas are (a synthesized high resolution image); wherein, when in the high resolution image generation step a high resolution image of an n-th similar area in the group (an n-th high resolution image) is produced by the image restoration processing, similarity index values between the image of the n-th similar area and the images of other similar areas are calculated; wherein the image of a similar area with a higher similarity index value is reflected more on the n-th high resolution image.

(g) A method for generating an image of semiconductor circuit patterns formed on a sample by using a scanning charged particle microscope, the image generation method comprising: an image input step to take in an image acquired by imaging the semiconductor circuit patterns using the scanning charged particle microscope (input image); a pattern of interest input step to take in a pattern of interest from the input image; a similar area group determination step to determine in the input image a group of areas having patterns similar in shape to the pattern of interest (a group of similar areas); a high resolution image generation step to produce from images of the similar areas a single resolution-enhanced image of an area having the pattern of interest (a high resolution image); and a pattern shape evaluation step to measure dimensions of the pattern of interest or extract an outline of the pattern of interest by processing the high resolution image.

(h) A method for generating an image of semiconductor circuit patterns formed on a sample by using a scanning charged particle microscope, the image generation method comprising: an image group input step to take in a plurality of images acquired by imaging the semiconductor circuit patterns multiple times by using the scanning charged particle microscope (a group of input images); a similar region categorizing step to identify among the input images a region having at least two similarly shaped patterns (similar pattern categorized region) and a region with no such patterns (non-similar pattern categorized region); a similar area group determination step to determine in the similar pattern categorized region a group of areas used for image restoration processing (a group of similar areas); and a high resolution image generation step to produce a single resolution-enhanced image of a similar area (high resolution image) from images of the group of similar areas by the image restoration processing; wherein each of the similar areas in the group includes a similarly shaped common pattern; wherein the similar areas are determined based on an index value (similarity index value) representing the number of the similar areas in the group and the similarity levels between images of the similar areas in the group.

(i) A method for generating an image of semiconductor circuit patterns formed on a sample by using a scanning charged particle microscope, the image generation method comprising: an imaging field of view setting step to set an imaging position and an imaging range (an imaging field of view) at and in which an image is photographed by the scanning charged particle microscope; a design data input step to input design data from a field of view containing at least the imaging field of view; a similar area group determination step to determine based on the design data a group of areas in the imaging field of view that are used for image restoration processing (a group of similar areas); and a high resolution image generation step to produce a single resolution-enhanced image of a similar area (high resolution image) from images of the group of similar areas (a similar image group) by the image restoration processing; wherein each of the similar areas in the group includes a similarly shaped common pattern on the design data; wherein the similar areas are determined based on an index value representing the number of similar areas in the group and the similarity levels between images of the similar areas in the group, both calculated based on the design data.

(j) A method for generating an image of semiconductor circuit patterns formed on a sample by using a scanning charged particle microscope, the image generation method comprising: an imaging field of view group input step to input a plurality of imaging positions and imaging ranges (imaging field of view group) at and in which images are photographed by the scanning charged particle microscope; a design data input step to input design data from a plurality of fields of view containing a plurality of the imaging fields of view; an image group input step to input a group of images that have been acquired by imaging the plurality of the imaging fields of view by the scanning charged particle microscope (an input image group); a similar area group determination step to determine based on the design data a group of areas in the plurality of the imaging fields of view that are used for image restoration processing (a group of similar areas); and a high resolution image generation step to produce a single resolution-enhanced image of a similar area (high resolution image) from images of the group of similar areas (a similar image group) by the image restoration processing; wherein each of the similar areas in the group includes a similarly shaped common pattern on the design data; wherein the similar areas are determined based on an index value representing the number of similar areas in the group and the similarity levels between images of the similar areas in the group, both calculated based on the design data.

(k) A method for generating an image of semiconductor circuit patterns formed on a sample by using a scanning charged particle microscope, the image generation method comprising: an image input step to take in an image acquired by imaging the semiconductor circuit patterns using the scanning charged particle microscope (input image); a similar area group determination step to determine in the input image a group of areas to be used for image restoration processing (a group of similar areas); a high resolution image generation step to produce a single resolution-enhanced image of a similar area (high resolution image) from images of the group of similar areas by the image restoration processing; an exceptional area sorting step to further divide each of the similar areas in the group into a plurality of areas (a group of divided areas) and sort images of the divided areas into ones that are similar to one another (similar divided areas) and ones that are not (exceptional areas); and a synthesized high resolution image generation step to generate a synthesized high resolution image by pasting high resolution images corresponding to the similar divided areas at positions where the similar divided areas are and also pasting, at positions where the exceptional areas are, those portions of the input image that correspond to the exceptional areas and which have undergone interpolation and expansion.

### Advantageous Effects of Invention

With this invention, it is possible to provide an image generation method and its device and a sample observation method and its device that produce images with a high resolution while minimizing damages that electron beams cause to the samples when their images are taken using a scanning charged particle microscope.

### BRIEF DESCRIPTION OF DRAWINGS

FIG. 1 shows a construction of a SEM used to accomplish the present invention.

FIG. 2 is a flow diagram showing an entire process in this invention to enhance the resolution of one SEM image taken in.

FIG. 3 shows how similar patterns are extracted from the input SEM image in this invention.

FIG. 4 shows how an image with a high resolution is generated in this invention from a plurality of extracted images of similar patterns.

FIG. 5 shows an example of generating a high resolution image in this invention by changing parameters of the image restoration processing for each area of the extracted similar patterns.

FIG. 6 shows how a pattern shape evaluation is performed based on the generated high resolution image in this invention.

FIG. 7 is a flow diagram showing an overall process to enhance the resolution of a pattern of interest in this invention.

FIG. 8 is a flow diagram showing an overall process in this invention to generate one high resolution image from a plurality of SEM images taken in.

FIG. 9 is a flow diagram showing an overall process in this invention to enhance the resolution of a SEM image by using design data.

FIG. 10 shows how similarly shaped patterns are extracted by using design data in this invention.

FIG. 11 shows how an imaging field of view is determined using design data in this invention.

FIG. 12 shows an example of discrepancies found between design data and patterns on a SEM image in this invention.

FIG. 13 shows an example application of this invention to line patterns.

FIG. 14 shows an example application of this invention to hole patterns.

FIG. 15 shows an example application of this invention to complex mask patterns.

FIG. 16 shows an example application of this invention to patterns obtained through double patterning.

FIG. 17 shows an example application of this invention to defect inspections.

FIG. 18 shows an entire system of this invention.

FIG. 19 shows a GUI with which to set parameters for extracting similar patterns in this invention.

FIG. 20 shows a GUI with which to set image restoration processing parameters in this invention.

FIG. 21 shows a GUI with which to determine an imaging field of view by using design data in this invention.

FIG. 22 shows how an area in which to perform image restoration processing is determined in this invention.

FIG. 23 is a flow diagram showing the execution of image restoration processing in this invention in which a weight of an image input to the image restoration processing is changed for each area where the image restoration processing is performed.

FIG. 24 shows an example application of this invention to pattern edges.

### DESCRIPTION OF EMBODIMENTS

The present invention relates to a device to generate high resolution images using a scanning charged particle microscope and also to a method using this device. Embodiments of this invention will be described for example cases where the invention is applied to a scanning electron microscope (SEM).

### 1. Construction of SEM

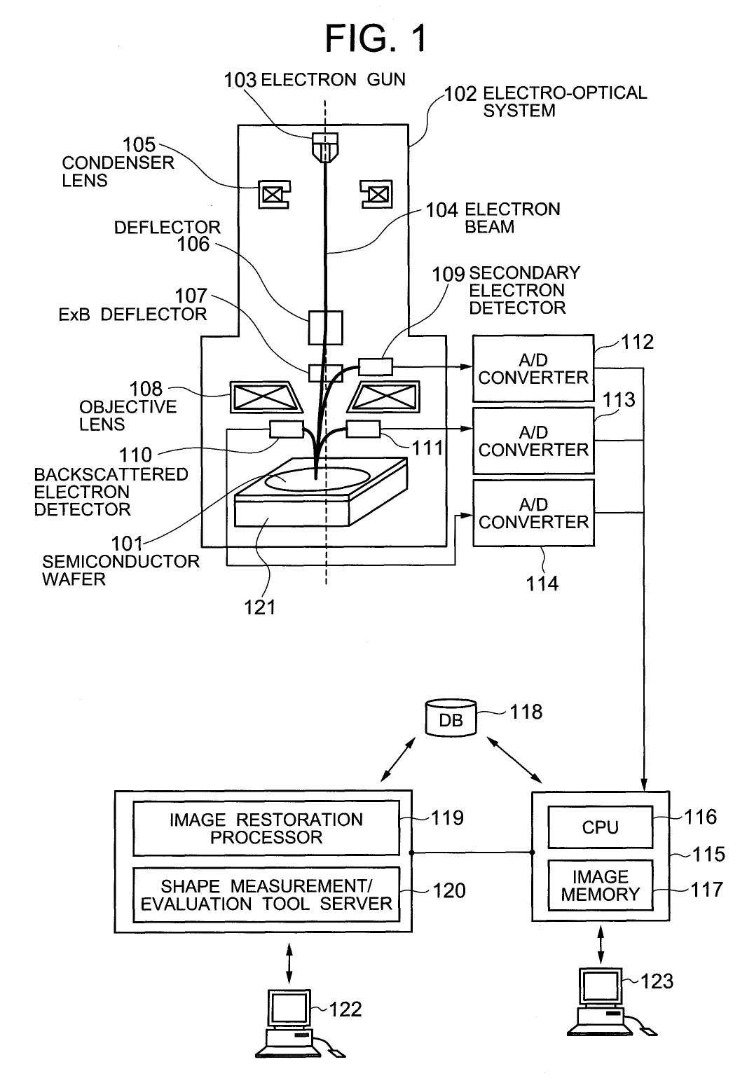

FIG. 1 is a block diagram showing an outline construction of a SEM that produces a secondary electron (SE) image or a backscattered electron (BSE) image of a sample. The SE image and the BSE image are generally called a SEM image. The image produced here include a part or all of a top-down image obtained by emitting electron beams in a vertical direction to an object being measured or a tilt image produced by emitting electron beams to the sample at a desired inclined angle.

An electro-optical system 102 has an electron gun 103 installed therein to produce electron beam 104. The electron beam emitted from the electron gun 103 are throttled by a condenser lens 105 into a narrow beam that is controlled in its irradiation position and field stop by a deflector 106 and an objective 108 so that the narrow electron beam is focused at a desired position on a semiconductor wafer 101, or a sample being measured, placed on a stage 121. Upon being irradiated with the electron beam, the semiconductor wafer 101 releases secondary electrons and backscattered electrons, with the secondary electrons deviated off a path of the electron beam by a deflector 107 and detected by a secondary electron detector 109. The backscattered electrons on the other hand are detected by backscattered electron detectors 110, 111. The two backscattered electron detectors 110, 111 are installed in directions different from each other. The secondary electrons and backscattered electrons detected by the secondary electron detector 109 and the backscattered electron detectors 110, 111 are converted by A/D converters 112, 113, 114 into digital signals, supplied into a processing and control unit 115 and stored in an image memory 117, after which these signals are image-processed by a CPU 116 as required. In this invention, image restoration processing is performed on a SEM image stored in the image memory 117 to enhance the resolution of the SEM image. It is also possible to store the SEM image in a database 118 and perform the resolution enhancement operation on the SEM image by using an image restoration processor 119. Further, for the SEM image or the resolution-enhanced SEM image, evaluations may be made of their pattern dimensions and shapes by using a shape measurement/evaluation tool server 120. These devices and server 116, 117, 119, 120 are connected to processing terminals 122, 123 that have GUI (Graphic User Interface with input/output devices such as display, keyboard and mouse) to show the results of processing to, or receive inputs from, the user.

Although in FIG. 1 an embodiment with two BSE image detectors has been shown, the BSE image detectors may be eliminated or their number may be reduced or increased. While the two independent processing terminals 122, 123 have been shown in this example, only one processing terminal may be used or two or more of them may be remotely installed, connected through a network.

### 2. Image Resolution Enhancement Processing

Now, examples of processing to enhance the resolution of a SEM image taken by a SEM of this invention will be described. The processing is characterized in either of the embodiments by the fact that it involves extracting, from an image of a semiconductor circuit pattern photographed and acquired by a SEM, a plurality of areas (similar areas) having similarly shaped patterns and then executing the image restoration processing using the image data of the plurality of extracted similar areas. This allows a large number of pieces of image data of the semiconductor circuit to be supplied into the image restoration processing even when the number of images taken of the semiconductor circuit pattern is small, making it possible to enhance the resolution of the semiconductor pattern image while minimizing damages to the sample.

An example of image restoration processing may involve taking in a group of images having a plurality of similar shape patterns, aligning the positions of images in each group at a subpixel level, and taking an arithmetic mean of upsampled images to generate one image with an enhanced resolution. An alternative method may use an image degradation model of a SEM image (image blurs caused by electron beams of SEM, noise, quantization of density levels or downsampling) and, based on the group of the photographed images, estimate an image removed of influences of the image degradations. In that case, the resulting restored image can be obtained by minimizing D(X) in Math. 1.

$$D ( X ) = {\sum }_{i = 1}^{N} \vert {DFS}_{i} X - {Y}_{i} \vert + H ( X ) \qquad [ Math . 1 ]$$

In Math. 1, Yi represents an i-th image in the group of N photographed images, X represents a high resolution image estimated by the image restoration processing, Si the amount of positional shift of subpixels in the i-th image, F the effect of a blur of the image, and D the effect of quantization. The first term in Math. 1 represents an error between the high resolution image X and the observed image Yi subjected to a variety of image degradation factors. The second term evaluates prior knowledge about the high resolution image X to be restored (e.g., continuity of pixel values of X). The processing to restore a high resolution image by minimizing Math. 1 is also referred to as a restructured ultrahigh resolution processing.

### Embodiment 1

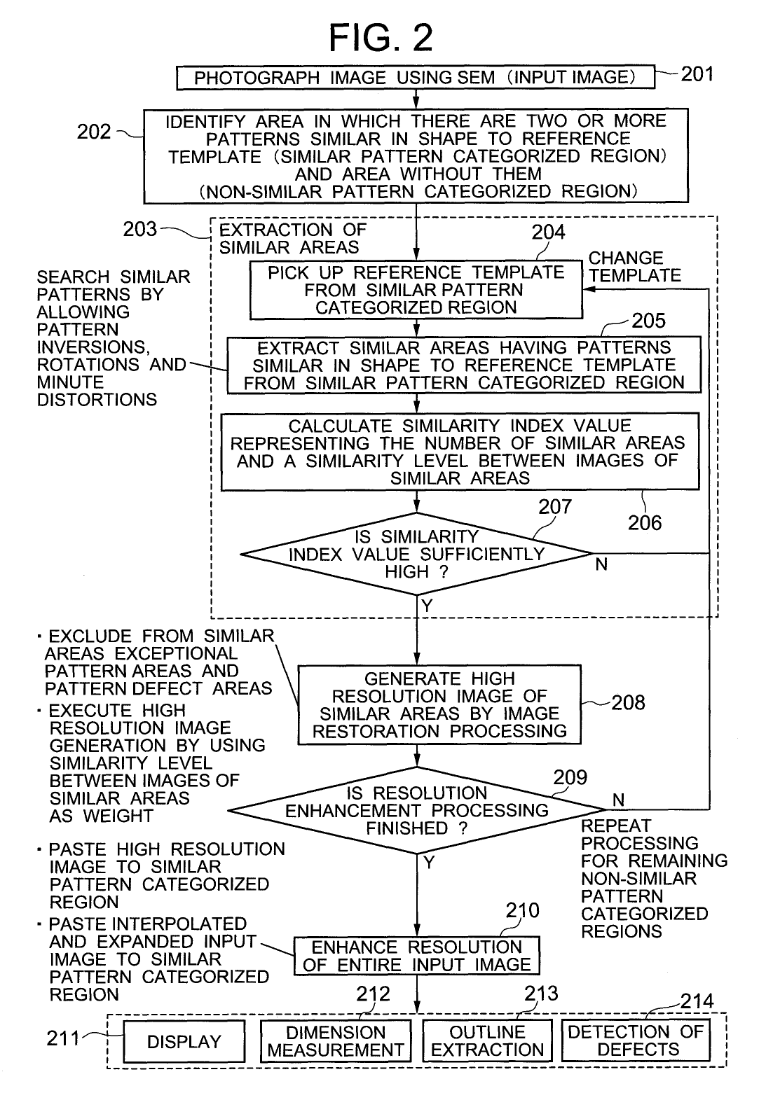

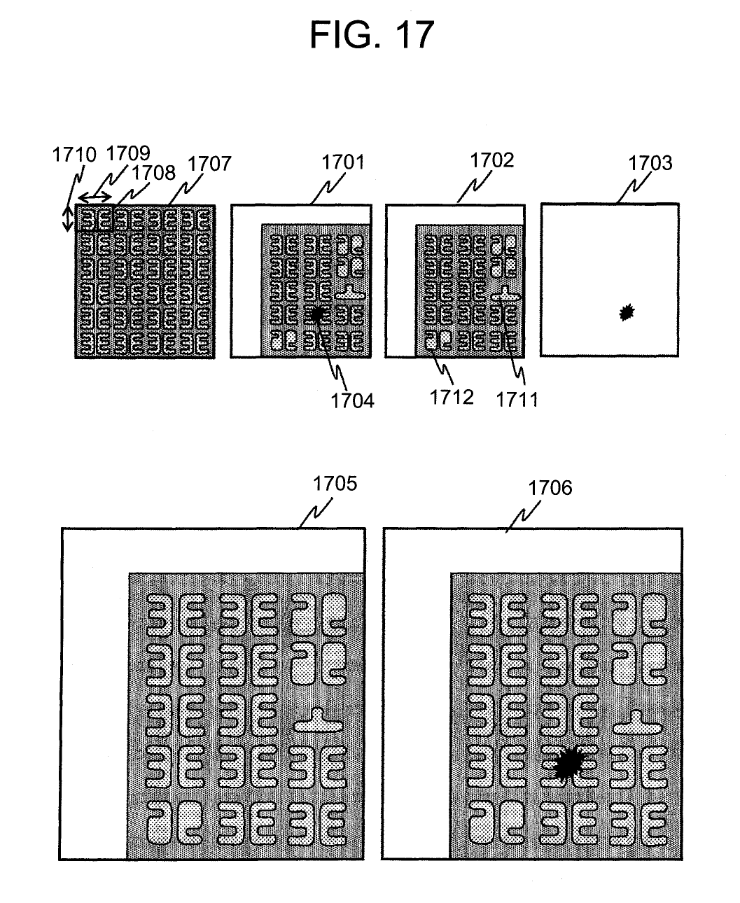

FIG. 2 is a flow diagram showing a process of enhancing the resolution of one image photographed by a SEM according to this invention. First, a SEM is used to take an image of a sample to acquire a SEM image (input image) (step 201). Then, a group of areas containing similarly shaped patterns (a similar area group) to be fed into the image restoration processing is extracted (step 203). There are, however, cases where the extraction of the similar areas in itself becomes difficult depending on the patterns contained in the SEM image. For example, in the case of a memory cell, such as shown at 1707 in FIG. 17, since one pattern repeats itself cyclically, simply entering a template for one cycle of pattern (image data in the area shown at 1708 in FIG. 17) and a pattern period (X-direction period 1709 and Y-direction period 1710) enables areas of the same period as that of the template to be sliced off the input image by shifting the template the distance corresponding to that period at a time. With this procedure, the similar areas can easily be extracted. However, in the case where a memory cell partly includes distinctive patterns as shown at 1702 in FIG. 17 (1711, 1712), the similar area extraction itself is difficult. To deal with this situation, before executing step 203, a check is made, as necessary, of the input image to identify an area in which there are two or more of similar patterns resembling each other in shape to which the image restoration processing can be applied (similar pattern categorized region) and an area without them (non-similar pattern categorized region) (step 202). Then, the image restoration processing is applied to a group of similar areas picked up from only the similar pattern categorized region. One possible method for finding the similar pattern categorized region and the non-similar pattern categorized region may involve dividing the input image into smaller sections and checking if there is a similar image with images of each region existed in the input image. In dividing the input image into smaller sections, design data, for example, may be used. Or data that was set when similar wafers were processed in the past may also be used. It is also possible to set a unit of division as the user watches the input image. With this categorization procedure, if the input SEM image includes distinctive patterns, the image restoration processing can be executed by avoiding them.

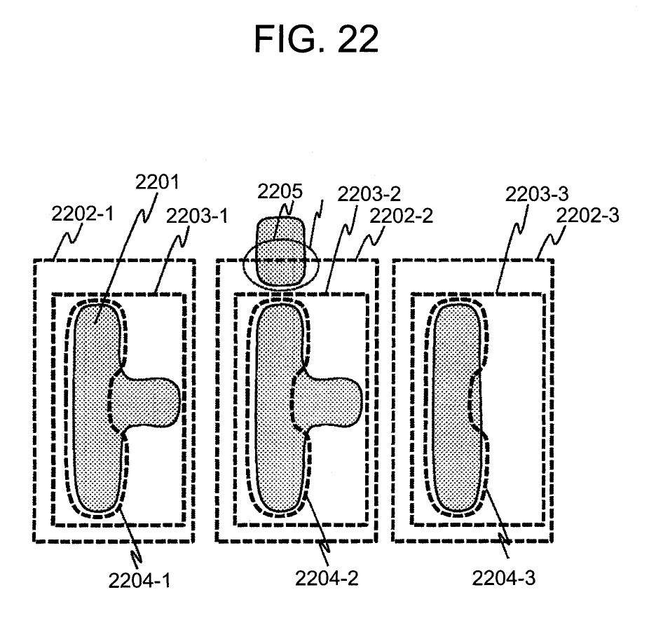

Next, a method of extracting a group of similar areas from the similar pattern categorized region determined at step 202 will be explained. First, a template that serves as a reference (reference template) for searching a group of similar areas is set (step 204). Then, the reference template and the similar pattern categorized region are compared for pattern matching to extract a group of areas similar to the reference template (similar area group) (step 205). Next, an index value representing the number of similar area groups and a level of similarity between images of the similar area groups (similarity index value) is calculated (step 206). If the similarity index is low, the position and size of the reference template are changed and the processing returns to step 204 (step 207). As described above, the reference template and the similar area group, both fed into the image restoration processing, are optimized. An example procedure to determine the reference template and the similar area group from a SEM image containing non-periodic patterns will be explained in more detail by referring to FIG. 22. Denoted 2201 is a pattern in a SEM image. First 2202-1 is set as a reference template. At this time, areas 2202-2 and 2202-3 similar in pattern shape to the reference template 2202-1 are extracted as a group of similar areas. But the similar area 2202-2 contains a pattern 2205 not included in the reference template 2202-1. So, if these similar area groups are used in the image restoration processing, the pattern 2205 is likely to emerge in a resultant high resolution image, which looks unnatural. To deal with this problem, the reference template is slightly reduced in size to set a second reference template 2203-1. At this time, areas 2203-2 and 2203-3 are extracted as a group of similar areas. Performing the image restoration processing using this similar area group does not result in the pattern 2205 emerging in the high resolution image as it did in the previous case. The reference template is not limited to a rectangle and may be set as shown at 2204-1 to 2204-3 or set in any desired shape. Although in this example the reference template 2202-1 is set again to deal with a case where the extracted similar areas include the pattern 2205 not contained in the reference template, it is possible not to use the similar area 2202-2 but to extract only the areas 2202-1 and 2202-3 as the similar area group. Such a reference template can be set by the user making an appropriate selection on a terminal device GUI as he or she watches the input image on the GUI.

Then, the image restoration processing is performed using a group of images of the similar areas (a group of similar images) (step 208). As described above, in the image restoration processing, as the number of image groups of similar in shape that are taken in increases, the resultant image obtained has a higher resolution. Generally semiconductor patterns include many laterally and vertically symmetrical patterns. So, in evaluating the level of similarity between two similar areas, when an image of one similar area after being turned or inverted resembles an image of the other area, the image similarity level between the two similar areas is set high. When imaging semiconductor circuit patterns by the SEM, there are cases where a part of the photographed image may be distorted by the sample becoming electrically charged by electron beam. Even in such a case, however, there is a possibility that the distorted image may be used in the image restoration processing if the distortions are corrected by image processing. So, by allowing some pattern distortions in addition to the aforementioned rotations and inversions, the shape similarity level is evaluated. Further, in the image restoration processing, it is also possible to subject the group of images to be taken in to the rotations, inversions and minute distortions before they undergo the image restoration processing. As described above, the evaluation of the level of pattern similarity by accommodating some degrees of deformations can increase the number of images to be input to the image restoration processing.

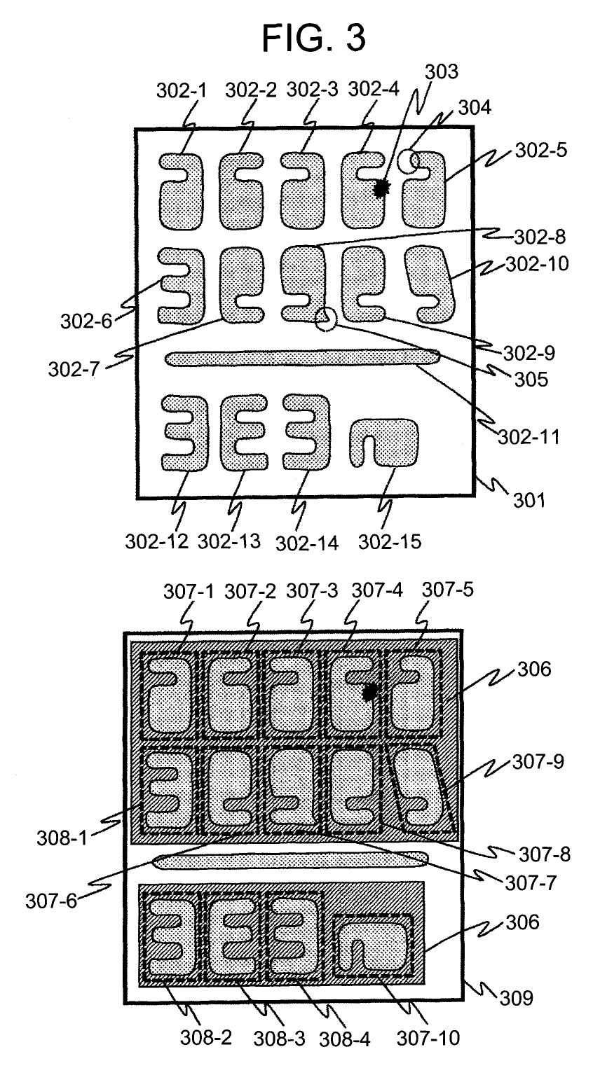

FIG. 3 shows an example of a similar pattern categorized region and an example of how a group of similar areas are extracted. The area 301 is an input image taken by a SEM and includes patterns 302-1 to 302-15. The pattern 302-4 contains an extraneous object 303, the pattern 302-5 has one part chipped away (304), and the pattern 302-8 has one part thickened (305). The pattern 302-10 is distorted at an angle. The patterns 302-1, 302-2, 302-7, 302-9, 302-10, 302-15 match in shape if they undergo lateral and vertical rotations, a right angle rotation or a correction of tilted distortions. The patterns 302-4, 302-8, 302-5, though they include the particle 303 or pattern defects 304, 305, are similar in other parts. The area 309 shows the same SEM image as that of 301. The similar pattern categorized regions are extracted as shaded areas 306 in 309. Next, the execution of the extraction of similar areas from the similar pattern categorized regions 306 results in two groups of similar areas being extracted, one containing patterns of 307-1 to 307-10 and the other containing patterns of 308-1 to 308-4. In step 208, both of the first group of similar areas 307-1 to 307-10 and the second group of similar areas 308-1 to 308-4 will undergo the image restoration processing.

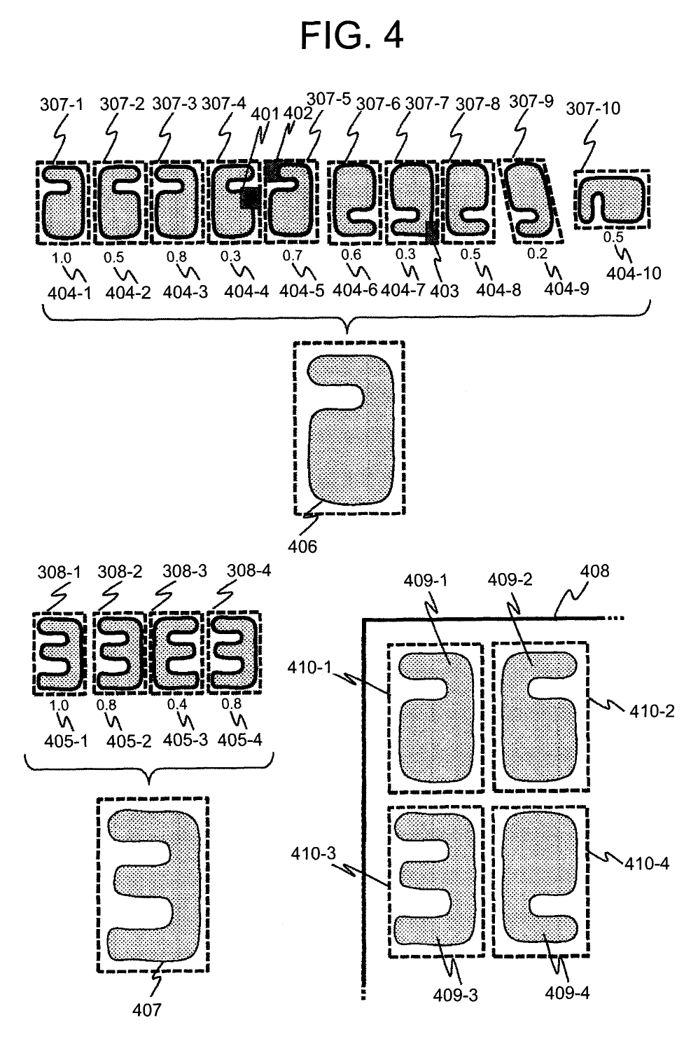

In the image restoration processing step 208, when particles or pattern defects are included in similar image groups to be input into the image restoration processing, there is a possibility of the finally obtained high resolution image reflecting the images of the particles and pattern defects and thereby looking unnatural. One solution to this problem may involve picking up from the extracted similar area group those areas containing exceptional shapes such as particles and pattern defects (exceptional areas) and using in the image restoration processing an image group of the similar area group removed of the exceptional areas. An example procedure for picking up the exceptional areas will be explained by referring to FIG. 4. An area group 307-1 to 307-10 and an area group 308-1 to 308-4 in FIG. 4 represent similar area groups extracted from the input image 301 of FIG. 3. Portions 401-403 are the result of extracting those areas containing the particle 303 and pattern defects 304, 305 of FIG. 3 as exceptional areas. More specifically, the method of picking up the exceptional areas consists in inverting or rotating the first group of similar areas 307-1 to 307-10 vertically or laterally or adding minute distortions to them for image matching, producing an average of these images, calculating a difference between the average image and each of the images in the group, and then taking those pixels with large differences as exceptional areas.

In the image restoration processing step 208, there are cases where, even after those areas of particles and pattern defects whose pixel values are greatly offset have been removed by the aforementioned exceptional processing, the similar image group that is to be input into the image restoration processing may still include those similar images which, though they are similar in pattern shape to the rest of the group, have dissimilar image qualities in terms of brightness, noise volume and pattern edge signal profile (edge profile). In such cases, there is a possibility that the finally restored high resolution image may be greatly influenced by a part of the similar images with such dissimilar image qualities. Factors contributing to such dissimilar image qualities include a scan direction of electron beam in the SEM photography. So, to ensure that the image restoration processing can be executed robustly even when images to be input into the image restoration processing have image quality variations, an index representing a level of pattern similarity (shape similarity index) is calculated for each of the images of similar areas to be fed into the image restoration processing and a similar image with higher shape similarity index is reflected on the finally produced high resolution image more than others. An example procedure for calculating the shape similarity index will be explained by referring to FIG. 4. The image restoration processing is assumed to be performed with the pattern 307-1 as a reference. It is also assumed that the shape similarity index of the pattern 307-1 is 1 (404-1). The pattern 307-3 is very similar in shape to the pattern 307-1 and its shape similarity index is 0.8 (404-3). The pattern 307-5, if removed of the exceptional area 402, is very similar to the pattern 307-1 and thus has a shape similarity index of 0.7 (404-5). The patterns 404-2, 404-4, 404-6, 404-7, 404-8, 404-9 and 404-10, if subjected to the vertical and lateral inversions and rotations and distortion corrections, are similar to one another but, depending on the electron beam scan direction, may have different pattern edge image profiles and therefore are given low shape similarity indices. For the patterns 308-1 to 308-4, their shape similarity indices are similarly calculated (405-1 to 405-4).

The patterns 406 and 407 in FIG. 4 represent high resolution images that have been enhanced in resolution by the image restoration processing from the image groups of the first group of similar areas 307-1 to 307-10 and the second group of similar areas 308-1 to 308-4. It is also possible to produce an image that has the high resolution images attached to where the similar area groups exist (synthesized high resolution image). That is, although the image restoration processing is a procedure to generate one highly defined image representing the similar area groups from the images of a plurality of similar areas, the positional relationship among the patterns in the similar area groups cannot be known from the generated high resolution image. The synthesized high resolution image, however, allows one to easily understand the positional relationship among the patterns of the similar area groups. In addition, for those similar areas that could not be enhanced in resolution, pixels generated simply by interpolating and extending the input image may be pasted together to produce a high resolution image of the entire input image (synthesized high resolution image). The area 408 in FIG. 4 shows an upper left portion of the resolution-enhanced whole input image 301 in FIG. 3. Here, resolution-enhanced images 406 and 407 (409-1 to 409-4) are pasted at positions 410-1 to 410-4 corresponding to the similar area groups 307-1, 307-2, 307-6, 308-1 in the input image 301.

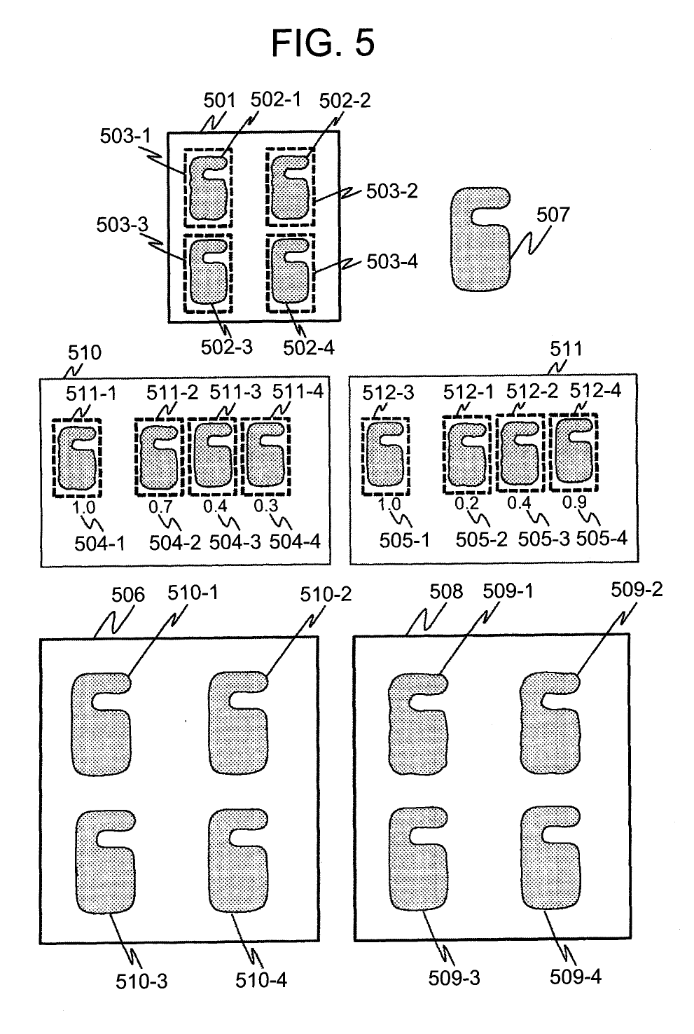

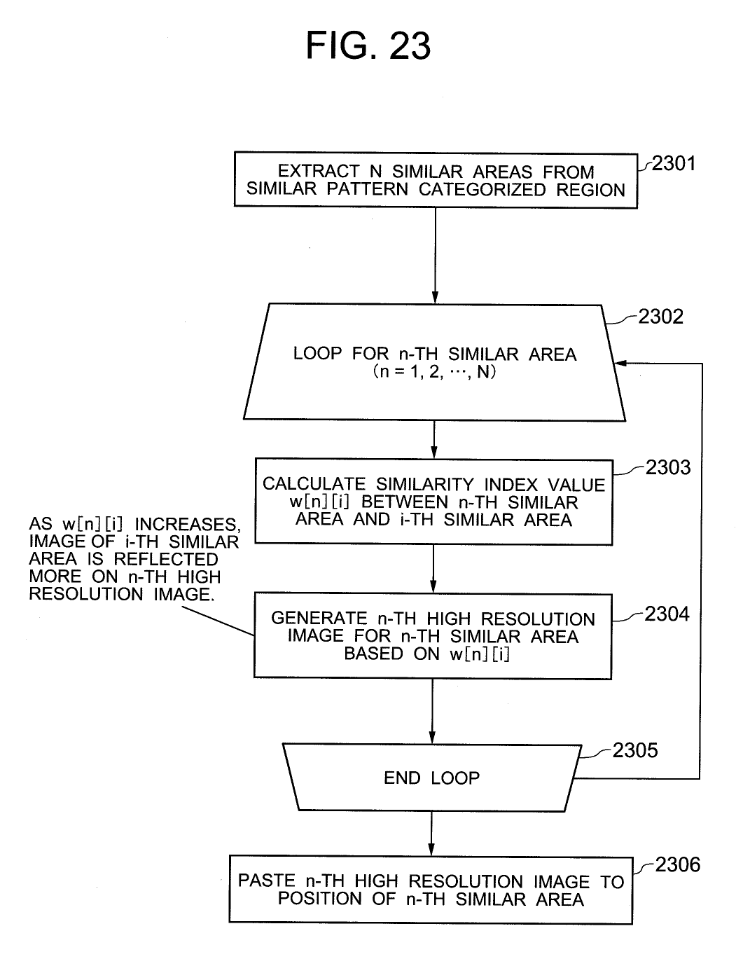

If, in the original input image, patterns differ slightly in shape among the similar areas, a final synthesized high resolution image produced by the method described above will end up having all their patterns formed of the same shape. This will be explained by referring to FIG. 5. Patterns 502-1 to 502-4 in the input image 501, for example, differ from one another in pattern edge roughness. Performing the image restoration processing on these patterns by extracting a group of similar areas 503-1 to 503-4 results in one high resolution image 507. Denoted 506 is a synthesized high resolution image obtained by pasting the high resolution image 507 at positions of the similar areas 503-1 to 503-4. Reference numerals 510-1 to 510-4 represent the pasted high resolution image 507. Although the entire input image 501 is found to be enhanced in resolution, minute shape differences that existed among the patterns prior to the processing are eliminated. To deal with this problem, a similarity index value is calculated for each of the similar areas before the image restoration processing is carried out. The flow of this procedure will be explained by referring to FIG. 23.

First, N similar areas are extracted by a similar area group extraction process (step 2301). Next, an n-th similar area (n=1 to N) in the similar area group is considered (step 2302). An image similarity index value w[n][i] (i=1 to N, i≠n) between the n-th similar area and an i-th similar area is calculated (step 2303). Then, when performing the image restoration processing to generate a high resolution image of the n-th similar area (n-th high resolution image), an arrangement is made to ensure that the image of a similar area with a high similarity index value w[n][i] is reflected more than other areas on the n-th high resolution image (step 2304). For example, the n-th high resolution image can be produced by interpolating and expanding the image of each similar area and taking a weighted arithmetic mean of these similar area images with their indices w[n][i] used as their own weights. The high resolution image can also be produced by executing the restructured ultrahigh resolution processing, shown at Math 2, to minimize Math. 1 with the index w[n][i] used as a weight.

$$D ( {X}_{n} ) = {\sum }_{i = 1}^{N} ( \vert {DFS}_{i} {X}_{n} - {Y}_{i} \vert \times w [ n ] [ i ] ) + H ( {X}_{n} ) \qquad [ Math . 2 ]$$

Here Xn in Math. 2 represents a high resolution image of the n-th similar area. The processing up to this point is repeated for each similar area (step 2305). Then, the n-th high resolution images produced by the above processing are pasted to the n-th similar area (step 2306). This enables the entire input image to be enhanced in resolution while keeping the characteristic shape differences among the patterns of the similar areas in the group intact. An example of calculated similarity index is shown at 510 and 511 of FIG. 5. The similar areas 511-1 to 511-4 in 510 and 512-1 to 512-4 in 511 correspond to the similar areas 503-1 to 503-4 in 501. If we take the similar area 511-1 as an area of interest and assign it a similarity index of 1 (504-1), the area 511-2, which is similar to 511-1 in pattern edge roughness, is given a similarity index of 0.7 (504-2). On the other hand, the patterns 511-3, 511-4 differ in pattern edge roughness from the pattern 511-1 and are thus assigned low similarity indices (504-3, 504-4). Performing the image restoration processing using these similarity indices of 504-1 to 504-4 results in a high resolution image 509-1. Similarly, when we take the similar area 512-3 as an area of interest, the similarity indices will be as shown at 505-1 to 505-4. Performing the image restoration processing on these areas using the similarity indices 505-1 to 505-4 produces a high resolution image 509-3. As described above, even if the same group of similar areas is used in the image restoration processing, the shape differences among the patterns can be left intact as the resolution of the entire input image is enhanced, by changing the similarity indices of individual patterns each time the area of interest is shifted.

Now referring back to the flow diagram of FIG. 2, step 208 produces a high resolution image through the image restoration processing by removing exceptional pattern areas and defective areas from the group of similar areas or weighting the similarity level between the images in the similar area group. If all the necessary resolution enhancement processing fails to be finished, a further similar area group extraction is attempted in those areas determined as non-similar pattern categorized regions, by repeating steps 204-209 until all the necessary resolution enhancement processing is finished. Then, to enhance the resolution of the entire input image, processing such as pasting the high resolution images to the similar pattern categorized regions or pasting interpolated and expanded input images to the non-similar pattern categorized regions (step 210).

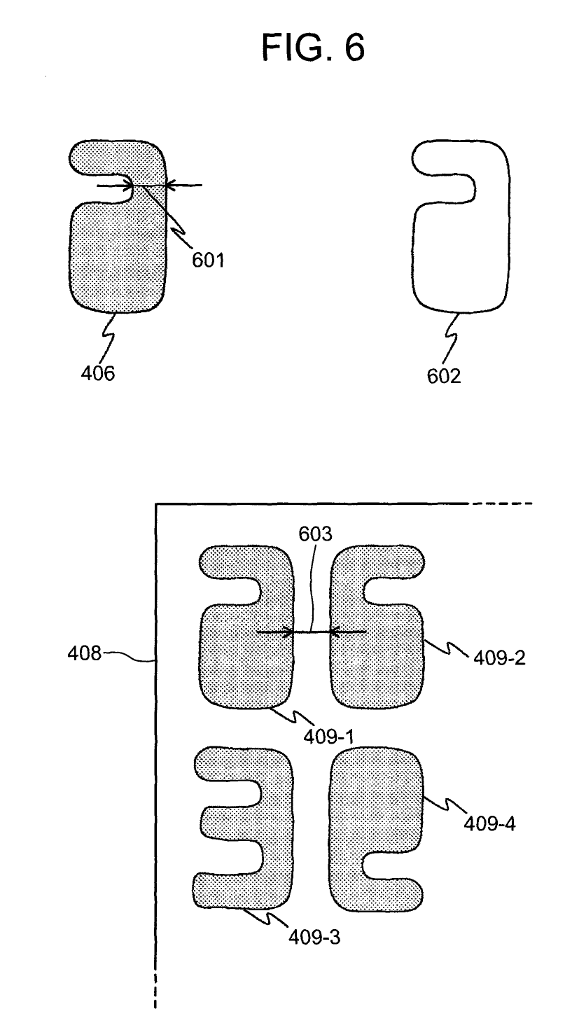

The high resolution image produced by the image restoration processing can also be displayed on a GUI (step 211). Further, by performing image processing on the high resolution images obtained by the image restoration processing, it is possible to measure pattern dimensions (step 212) or extract the outlines of patterns (step 213). For example, in the case of samples that have low resistance against electron beams, such as resist patterns, this processing allows the images of areas of interest, such as line patterns and hole patterns photographed with low magnifications by minimizing irradiation density of electron beams, to be enhanced high enough in resolution so that their dimensions can be measured with high precision. It is also possible to enhance the resolution of either images containing defects or images having the same patterns but not containing defects, or both, and compare these images for detection of defects (step 214). Referring to FIG. 6, an example of measuring the pattern dimensions of a high resolution image and an example of extracting a pattern outline will be explained. A pattern 406 in FIG. 6 is a pattern image that has been enhanced in resolution from the group of images of the similar areas 307-1 to 307-10 of FIG. 3. Reference number 601 represents a measured part of the pattern 406. The outline of the pattern 406 is extracted as shown at 602. These are obtained by using a resolution-enhanced image of one similar area, but the same processing can also be performed on the synthesized high resolution image 408. In that case, it is possible to measure a dimension between the resolution-enhanced patterns, as at 603, and extract a pattern outline of the entire synthesized high resolution image 408.

### Embodiment 2

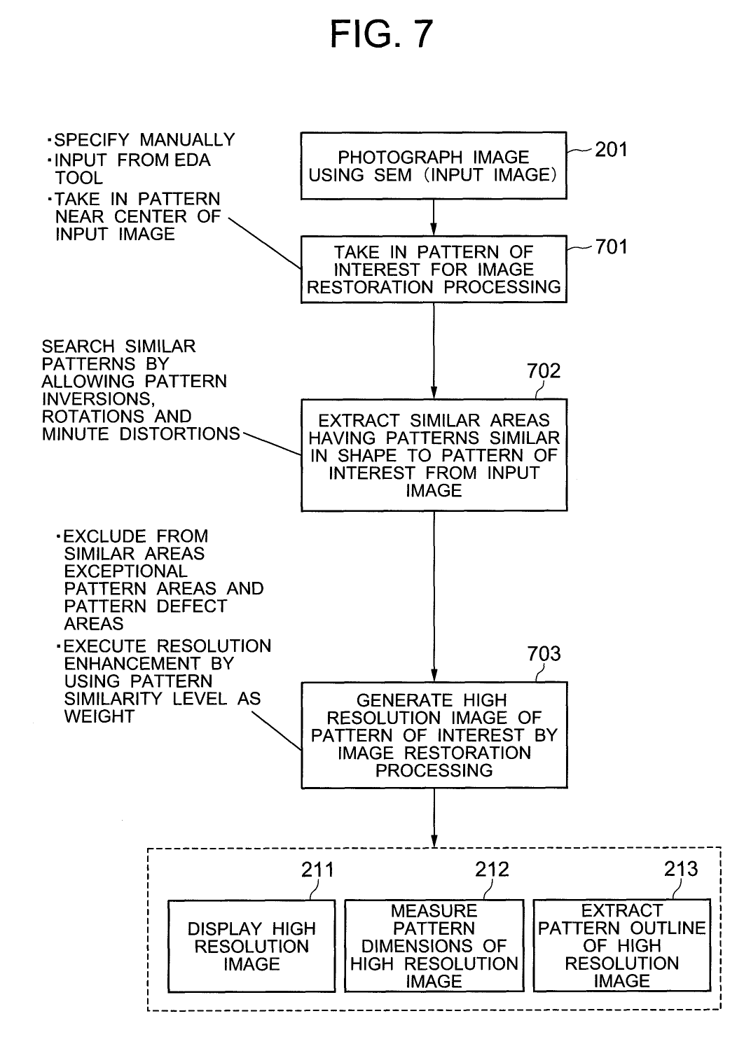

While the processing described in Embodiment 1 involves extracting from the input image those areas for which the image restoration processing can be carried out and enhancing the resolution of the extracted areas, if only a part of the input image is to be checked for evaluation of the pattern shapes, there are cases where only that part of the input image needs to be enhanced in resolution. In these cases, the processing to divide the input image into a group of areas that have patterns of similar shapes can be simplified. The flow of this processing will be explained by referring to FIG. 7. A variety of processing described in Embodiment 1 and in the flow diagram of FIG. 2 can also be applied as needed, although their explanations are omitted here.

First, an input image is photographed by a SEM (step 201). Next, a pattern (of interest) for which the image restoration processing is to be carried out is input (step 701). The pattern of interest may be manually input by the user as he or she watches an input image displayed on a GUI. Or a pattern picked up by an EDA (Electronic Design Automation) tool from the neighborhood of a critical portion called a hotspot, where defects are considered likely to occur, may be used. Furthermore, since the pattern to be evaluated in terms of shape is often shot in a way that puts it at a central part of the input image, the pattern of interest may be picked up from the central part of the input image.

Next, a group of areas whose pattern shapes are similar to the pattern of interest is extracted from the input image (step 702). This extraction processing may use, for example, the pattern matching between the pattern of interest and the input image, as in step 205 of Embodiment 1. As an example of applying the processing described in Embodiment 1 to this embodiment, the area of the pattern of interest may be modified as required.

Then, from the images of the similar areas in a group one high resolution image of the pattern of interest is generated by the image restoration processing (step 703). Now, the resolution-enhanced image can be displayed on the GUI or it may be used to measure pattern dimensions or extract pattern outlines (steps 211-213).

### Embodiment 3

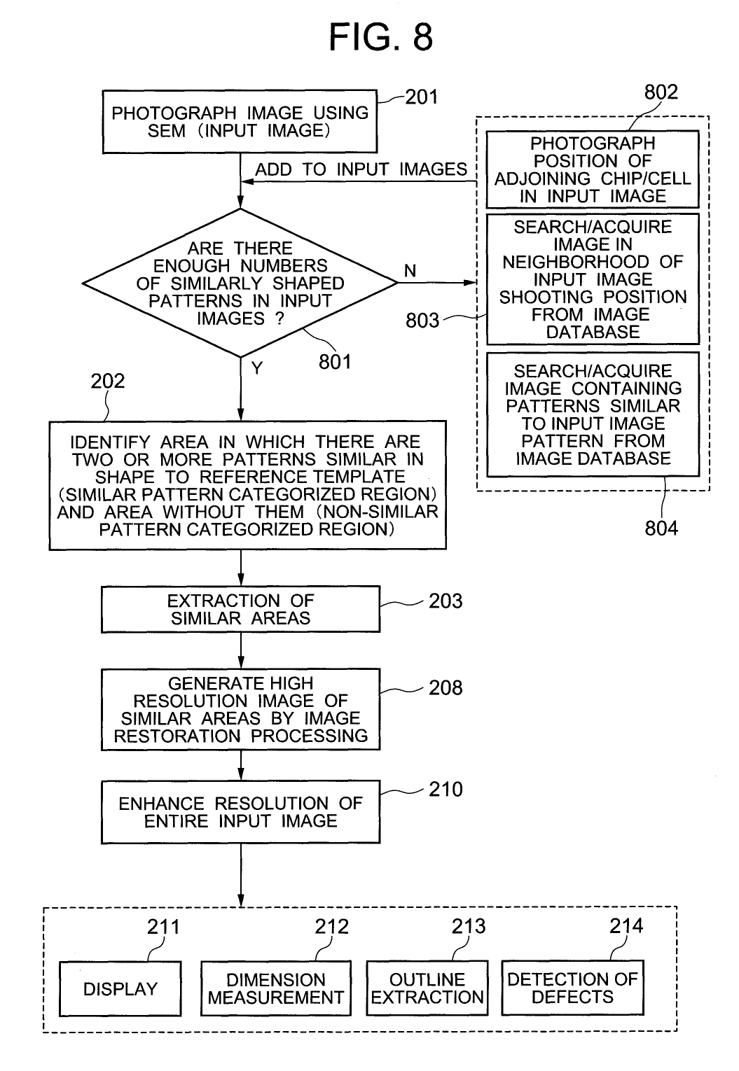

In Embodiment 1 the resolution enhancement processing involves searching through an input image to pick up areas with similar shape patterns and enhancing the resolution of these areas. With this method, however, if semiconductor circuit patterns are not dense enough, there may occur a case in which no similar patterns are found in one input image. Even under such a circumstance, the use of a plurality of SEM images in the image restoration processing allows the input image to be enhanced in resolution. One such example will be detailed by referring to FIG. 8. This processing extracts as many areas as possible, each containing a similarly shaped pattern, from among a plurality of images, rather than from one image, to improve the performance of the resolution enhancement by the image restoration processing. A variety of processing explained in Embodiment 1 and in the flow diagram of FIG. 2 can also be performed as necessary although their descriptions are omitted here.

First, a SEM is used to take a shot of a sample and obtain a first SEM image (first input image) (step 201). Next, a check is made as to whether there is a sufficient number of similarly shaped patterns in the first input image (step 801). If it is found that there are not as many similar patterns as will allow the image restoration processing to produce a desired resolution enhancement effect, a second SEM image is acquired and the similar decision to step 801 is made. These steps are repeated to acquire a plurality of input images. The second or subsequent input image may be acquired by imaging a chip or cell position adjoining the imaging position of the first input image (step 802) or taken from an image database that stores a collection of SEM images shot in the past. When an input image is taken from the image database, it is possible to pick up a SEM image whose imaging position is close to that of the first input image (step 803), or to check whether there is any pattern in the collection of past SEM images that is similar in shape to the first input image and, if so, extract it (step 804).

If it is decided that there are a sufficiently large number of similarly shaped patterns among a plurality of input images, the process proceeds to step 202 in the flow diagram of FIG. 2 where the associated steps are carried out.

### Embodiment 4

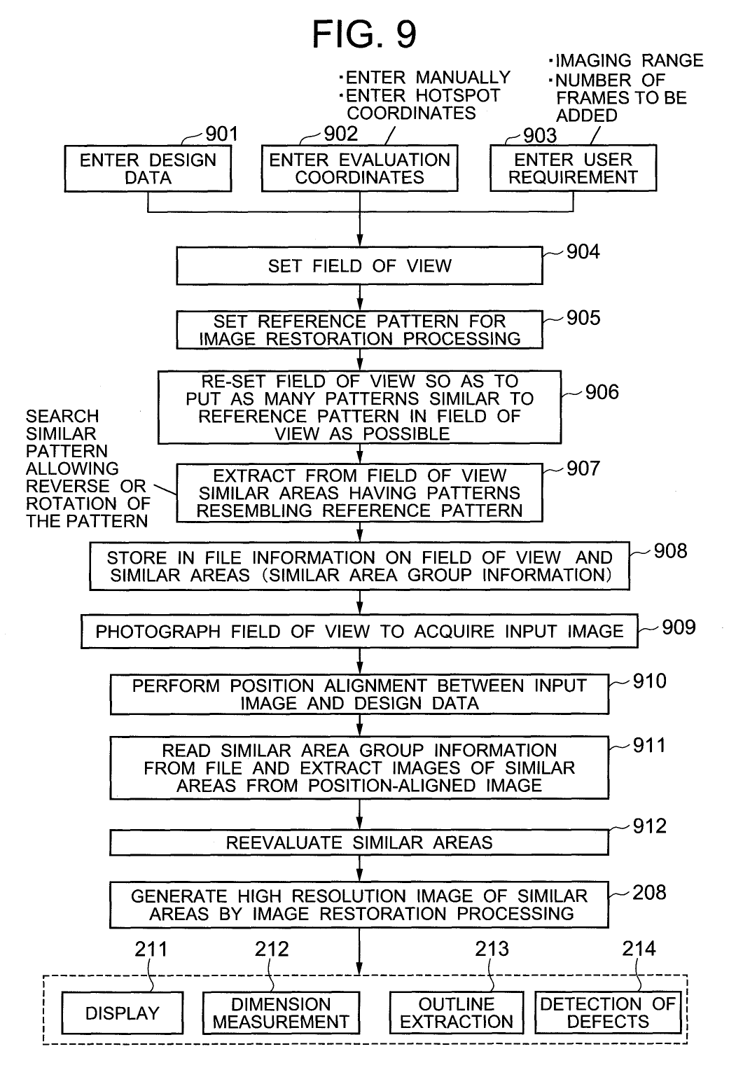

With the methods described in Embodiment 1 to 3, it cannot be known until an input image is shot whether there is an area in the input image that has similarly shaped patterns. Furthermore, in extracting similar patterns, if the input image is blurred or has a low resolution or a low S/N, a method that is based on image information, such as template matching, may not work at all. To cope with this situation, design data is used to search similar areas offline (no imaging apparatus is required) with a high level of robustness for quality variations of the SEM images. The process flow in executing the image restoration processing using design data will be explained by referring to FIG. 9. A variety of processing explained in Embodiment 1 and in the flow diagram of FIG. 2 can also be performed as necessary although their descriptions are omitted here.

First, design data on semiconductor circuit patterns is taken in (step 901). Coordinate values of patterns to be evaluated (evaluation coordinates) are also input (step 902). The evaluation coordinates may be specified by the user setting design data coordinates on the GUI or by the user inputting a hotspot where defects are considered likely to occur, which the EDA tool or etc. outputs. Next, a SEM imaging position and imaging range (imaging field of view) including the evaluation coordinates are set (step 904). The imaging conditions to be set may include the imaging range and the number of frames to be added, both entered at the user demand input step 903. Next, a pattern (reference pattern) for which the image restoration processing is to be executed is set within the field of view by using design data 901 (step 905). The reference pattern may be chosen from patterns located at the evaluation coordinates or near the central part of the field of view. Or it may be specified on the GUI by the user or two or more of the reference patterns may also be set. Next, the imaging field of view is set again for the reference pattern as required, based on the first field of view that was entered by using design data (step 906). The re-setting of the imaging field of view may, for example, be done so that the field of view will include on the design data as many areas having similar patterns in shape to the reference pattern (similar areas) as possible. This allows many similar areas to be taken into the image restoration processing which can be expected to produce higher resolution images.

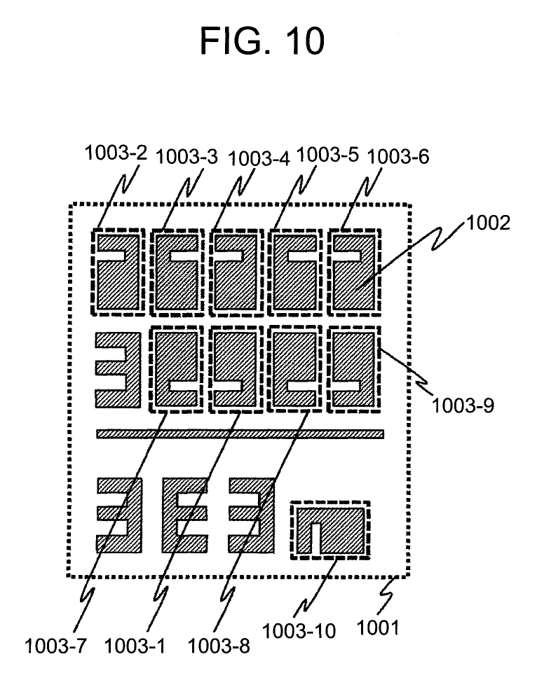

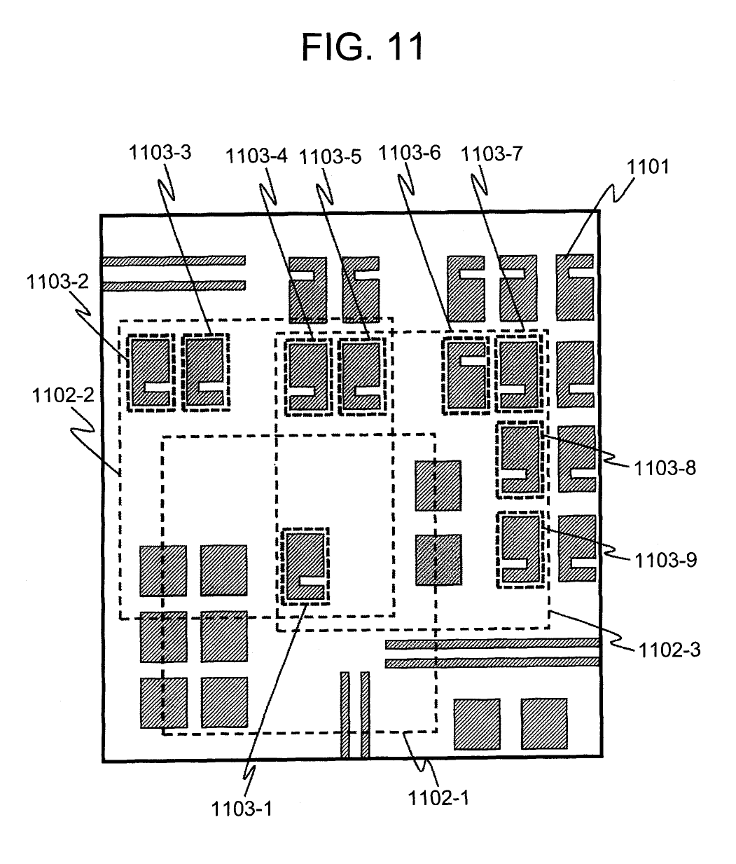

In the image restoration processing, the restored image can be made to have a higher resolution not only by an increased number of similar areas but also by a higher level of similarity between images of the similar areas. With this fact taken into account, the imaging field of view may be determined in a way that puts as many similar areas in the field of view as possible and which renders the level of similarity between the images of the similar areas as high as possible. Next, a group of areas having patterns similar to the reference pattern is extracted from within the imaging field of view that was re-set using the design data (step 907). By searching the similar areas on the design data, the search can be prevented from being influenced by the quality of input images (e.g., S/N and quantization errors). The similar area search can also be made by allowing vertical and lateral inversions and rotations of the patterns. It is noted that the steps 901-907 can be executed offline without using the SEM. The similar area search operation and the imaging operation by the SEM can be separated by storing the information on the imaging field of view and the group of similar areas extracted by steps 901-907 in a file (step 908) and reading the file to execute the processing. Next, the information on the field of view is read out from the file and the field of view is then imaged by the SEM to acquire a SEM image (step 909). Next, the input image and the design data are subjected to a position alignment (step 910). The position alignment at step 910 is required because, depending on the accuracy of the movement of a SEM stage and the accuracy of the scan position of an electron beam during an actual imaging operation, the input image may shift from the field of view, which in turn gives rise to a possibility of a positional shift occurring between the design data pattern and the input image pattern. Next, from the input image that was subjected to the position alignment performed by reading the similar area group information from the file, images at positions where the similar areas in the group exist (similar image group) are taken out (step 911). An example procedure for searching a group of similar areas by using the design data will be explained by referring to FIG. 10. Denoted 1001 is a selected imaging field of view and shaded areas 1002 represent patterns of design data in the field of view. Denoted 1003-1 is a reference pattern selected. Areas 1003-2 to 1003-10 are a group of similar areas that have been extracted as being similar in shape to the reference pattern. Next, an example procedure for re-setting the imaging field of view using the design data so that the image restoration processing can work well will be explained by referring to FIG. 11. Shaded areas 1101 represent input patterns of design data. Denoted 1102-1 is a first field of view set by step 904. A pattern 1103-1 at around a central part of the first field of view 1102-1 is extracted as a reference pattern for which the image restoration processing is to be carried out. However, since there is no other pattern in the first field of view 1102-1 resembling the shape of the reference pattern, the image restoration processing cannot be performed. In that case, the imaging field of view is re-set so that it will contain as many areas having similar patterns in shape to the reference pattern 1103-1 (similar areas) as possible and still include the reference pattern 1103-1. Denoted 1102-3 is a new imaging field of view obtained as a result of changing the imaging position so that the field of view contains a maximum number of similar areas and still includes the reference pattern 1103-1. This repositioning of the imaging field of view by allowing vertical and lateral inversions and rotations of patterns in the search of similar patterns has resulted in six similar areas 1103-4 to 1103-9 being extracted. That is, the acquisition of a SEM image whose field of view has been changed from 1102-1 to 1102-3 has made it possible to put many images similar in shape to the reference pattern 1103-1 into the image restoration processing and thereby generate a resolution-enhanced image of the reference pattern 1103-1.

Further, an actual SEM image may change in pattern edge image profile depending on the direction of scan of electron beam. That is, although the patterns 1103-4, 1103-6 to 1103-9 can be made to match the reference pattern 1103-1 on the design data through their vertical or lateral inversions, their similarity level may remain low on the SEM image even after being simply subjected to the vertical and lateral image inversions because of the dependency of the scan direction. To cope with this situation, the pattern inversion and rotation may be taken as evaluation values in addition to the number of similar areas in re-setting the imaging field of view. For example, the field of view 1102-2, though it has only four similar areas, fewer in number than the field of view 1102-3, contains three patterns (1103-2, 1103-3, 1103-5) that resemble the reference pattern without having to be inverted laterally (the field of view 1102-3 includes only one such pattern 1103-5). Where the SEM image depends heavily on the scan direction of electron beam, re-setting the field of view to 1102-2 will provide a better chance of being able to produce a higher resolution image. It is also possible to calculate a plurality of candidates for the re-setting of the field of view and let the user select from among them on the GUI.

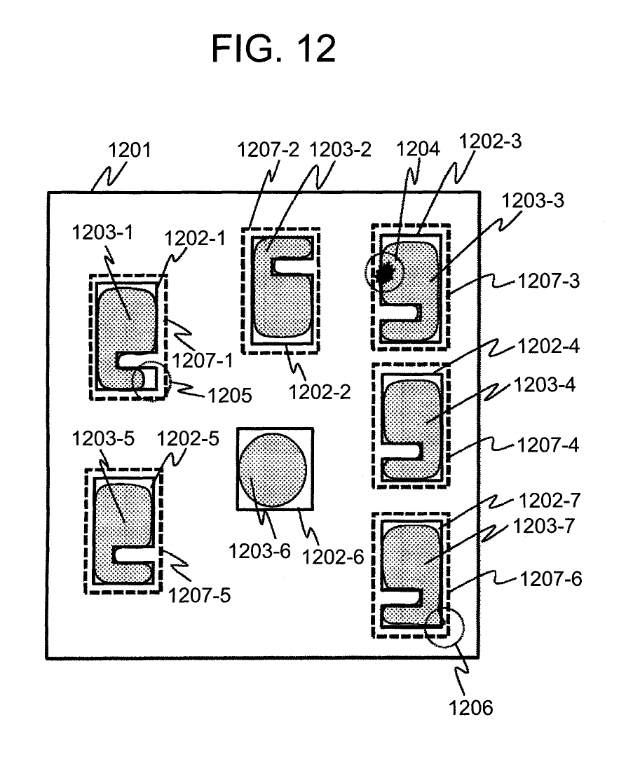

The level of pattern similarity for the similar area group can be re-evaluated using the similar image group (step 912). That is, in the procedure described above that checks the similarity level by using design data to pick up a group of similar areas, there is a case where an actual pattern formed on the wafer may deviate from the design data shape. For example, even patterns that have the same shapes on the design data may actually differ from each other depending on the surrounding patterns and the imaging position. There can also be a case where the actual pattern differs greatly from the design data pattern due to defects such as particles. To deal with this situation, the similarity levels between the similar areas is reassessed by using image data corresponding to the group of similar areas that has been extracted by using design data. This reassessment of the similarity levels consists in dividing the group of similar areas into a group of areas that have similar patterns and another group of areas that do not (exceptional area group). Then the image restoration processing can be carried out by removing the exceptional area group from the similar area group. An example procedure for reassessing the pattern similarity levels between similar areas in a group by using a SEM image will be explained by referring to FIG. 12. Denoted 1201 is a SEM image acquired by imaging the imaging field of view set at step 906 by a SEM. Denoted 1202-1 to 1202-7 is design data of patterns entered at step 901. The SEM image includes the patterns 1203-1 to 1203-7. Reference numerals 1207-1 to 1207-6 represent a group of similar areas extracted at step 907. The patterns 1203-1 to 1203-7 that are formed after undergoing exposure, development and etching process include rounded corners and tapered portions and there are discrepancies in shape from the design data pattern. They also include pattern defects, such as particles 1204 on the sample, chipped pattern (1205) and inflated pattern (1206), making the image outline of the parts of the pattern greatly different. So, performing the image restoration processing by using the images of the similar areas 1207-1 to 1207-6 will likely cause the images of particles and pattern defects to have large undesired effects on the finally obtained high resolution image. The effects that these defective portions have on the image restoration processing, however, can be minimized by superposing the images of part areas 1207-1 to 1207-6 for image comparison, extracting particles and pattern defects as exceptional areas and removing the exceptional areas from the group of similar areas in executing the image restoration processing.

After reassessing the pattern similarity levels of the similar areas in the group at step 912, the processing moves to step 208 in the flow diagram of FIG. 2 and follows the subsequent steps.

### Embodiment 5

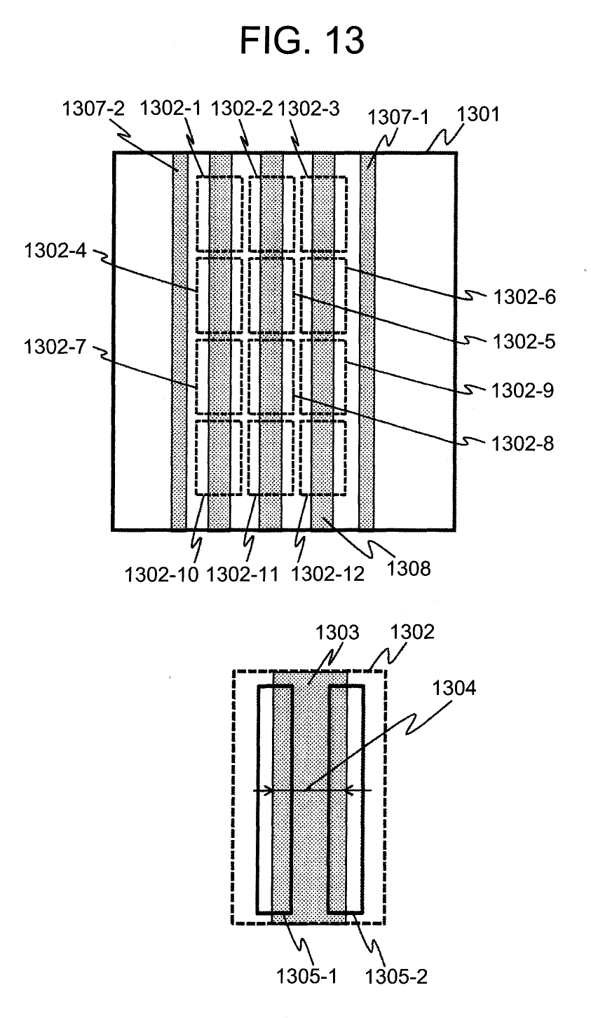

An example process of enhancing the resolution of a line pattern image taken by a SEM of this invention to measure line pattern dimensions with high accuracy will be explained by referring to FIG. 13. First, a field of view containing a line pattern whose dimension is to be measured is imaged by a SEM to acquire a SEM image 1301. At this time, an image is taken with a low magnification factor to reduce the amount of electron beam emitted in order to minimize damages to the sample by the beam. A low S/N and a low resolution of the SEM image 1301 make it difficult to measure dimensions with high precision by using image processing. To cope with this problem, areas 1302-1 to 1302-12 having similar shapes are extracted and the images of these similar areas are aligned in position before the image restoration processing is performed to acquire one resolution-enhanced SEM image 1303. Then, a pattern dimension measurement is made of the high resolution SEM image 1303. Here the line pattern area in which the pattern dimensions are to be measured may be extracted from the SEM image by the user specifying a first area (e.g., 1302-1) on the GUI to pick up areas having patterns similar to the first area pattern through pattern matching (e.g., 1302-2 to 1302-12). Alternatively, the first area may automatically be set to include a line pattern at a central portion of the input SEM image (e.g., 1302-8). Here, line patterns 1307-1 and 1307-2 have a wide space area on the left or right side thereof and therefore differ in dimension from the line pattern 1308 and are not extracted as similar areas. Then, two image processing ranges 1305-1, 1305-2, called measurement boxes, are assigned to the resolution-enhanced line pattern SEM image 1303, and in the two measurement boxes 1305-1, 1305-2 the positions of line edges are calculated and compared. These steps allow the dimension 1304 of the line pattern to be measured with high precision. The process of extracting line edge positions may involve, for example, acquiring from image data contained in the measurement boxes 1305-1, 1305-2 image density profile data perpendicular to the line edges and picking up as edge positions those positions where a gradient of the profile data changes greatly or where image density value peaks. It is also possible to first determine a plurality of edge positions in each of the measurement boxes and take an average of these edge positions as an edge position in each measurement box.

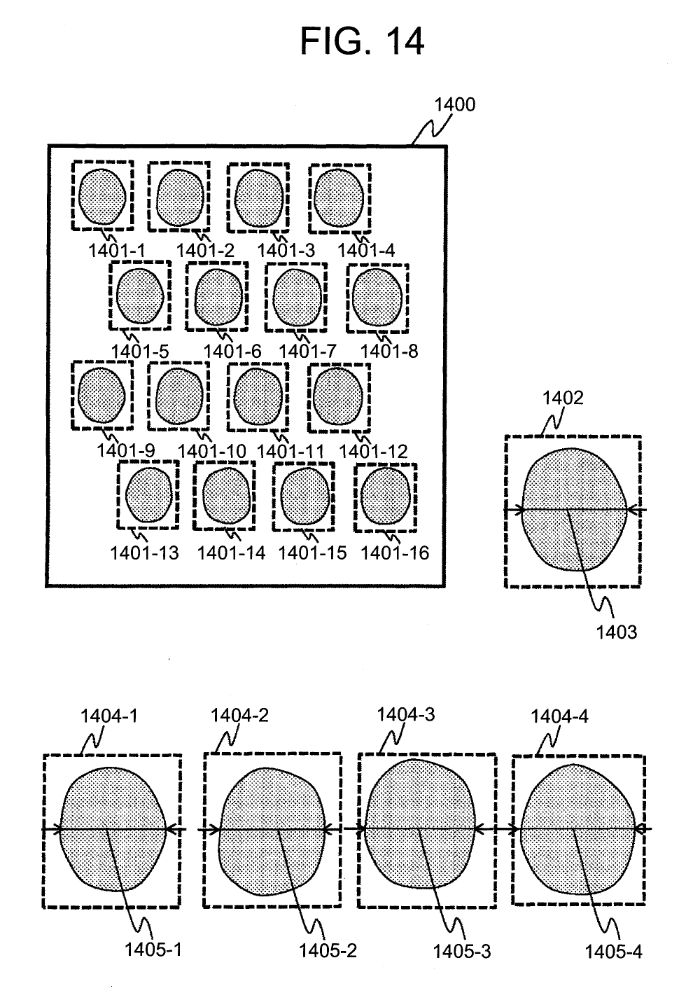

Next, an example process of enhancing the resolution of a hole pattern image taken by a SEM of this invention to measure hole pattern dimensions with high accuracy will be explained by referring to FIG. 14. First, the field of view including a hole pattern whose diameter is to be measured is imaged by a SEM of this invention to acquire a SEM image 1400. In this case too, as with the line pattern measurement described above, the image is normally taken with a low S/N and low resolution to minimize damages to the sample. Next, hole pattern areas 1401-1 to 1401-16 are extracted and images of these areas 1401-1 to 1401-16 are aligned in position before the image restoration processing is performed to acquire one resolution-enhanced hole pattern image 1402. This is followed by a measurement of a hole pattern diameter 1403 in the high resolution image 1402. Here it is also possible to acquire a plurality of high resolution hole pattern images 1404-1 to 1404-4 by dividing a group of hole pattern areas 1401-1 to 1401-16, that are to be input into the image restoration processing, (for example, into four groups of 1401-1 to 1401-4, 1401-5 to 1401-8, 1401-9 to 1401-12 and 14013-1 to 1401-16) and performing the image restoration processing on each of the divided groups of areas. For each of the hole pattern images 1404-1 to 1404-4 the measurement may be taken of the hole pattern diameter 1405-1 to 1405-4, so that an average and variations of these hole pattern diameters 1405-1 to 1405-4 can be evaluated. The above grouping is not limited to four groups and any suitable number of groups may be adopted.

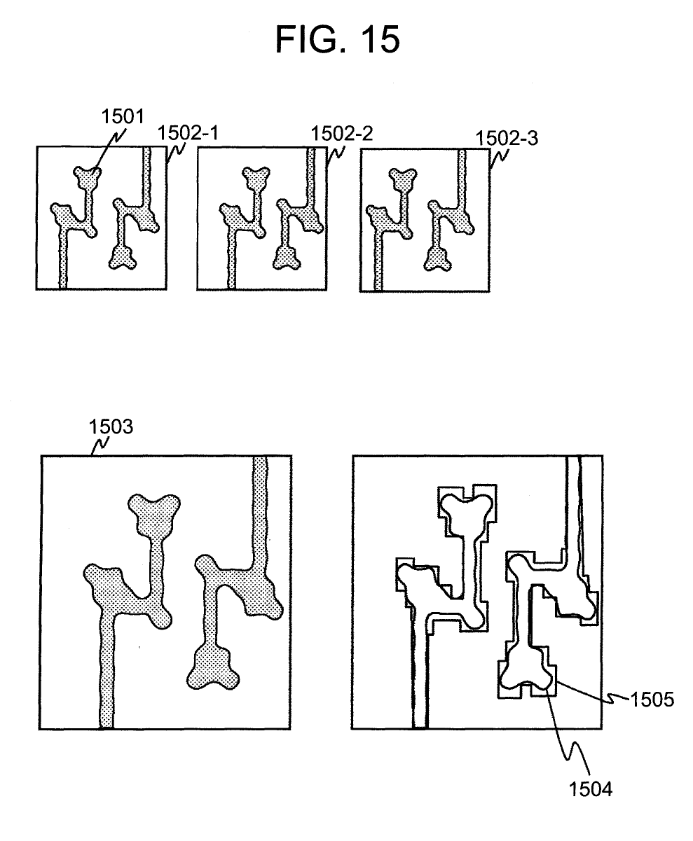

Next, an example process of enhancing the resolution of an image of complex mask patterns with OPC (Optical Proximity Correction), photographed by a SEM of this invention, to evaluate shapes with high accuracy will be explained by referring to FIG. 15. For a complex mask pattern with OPC, such as shown at 1501, to complete the image restoration processing is difficult because there are few other patterns of similar shapes. To get around this problem, a plurality of SEM images 1502-1 to 1502-3 having patterns of similar shapes are used for the image restoration processing to acquire a resolution-enhanced SEM image 1503. These SEM images 1502-1 to 1502-3 may be obtained by imaging the same coordinate position in adjoining chips or cells as the first imaging position of the SEM image 1502-1. From the generated high resolution SEM image 1503 a pattern outline (1504) may be extracted for comparison with design data of the mask pattern (1505) to evaluate its shape. The outline data may also be input to an exposure simulator to estimate the shape of a pattern to be transferred onto a wafer.

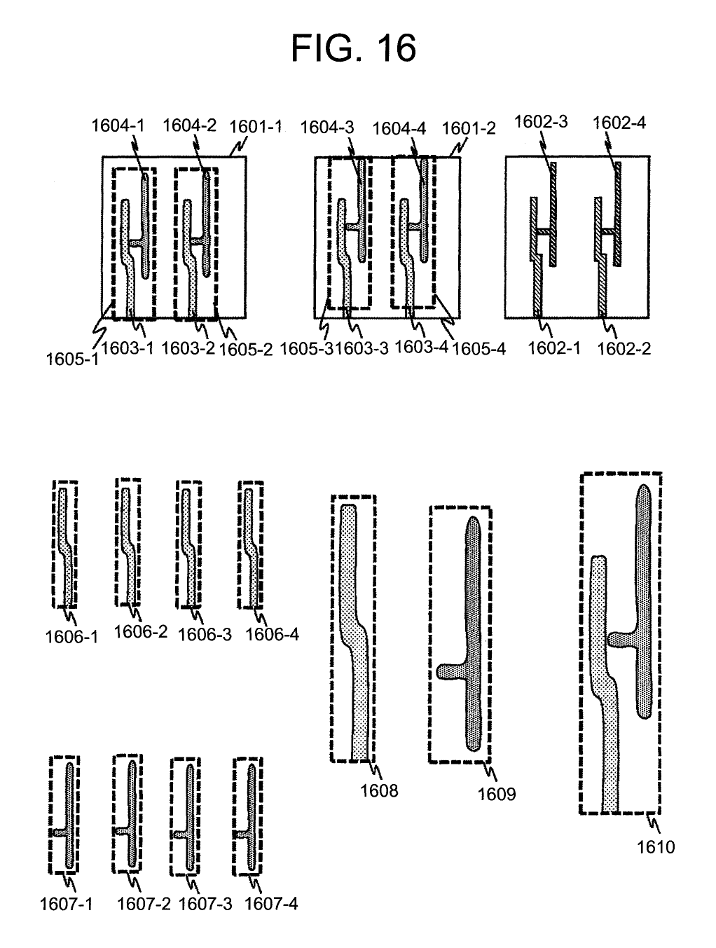

Next, an example process of enhancing the resolution of a pattern image taken by a SEM of this invention through double patterning will be explained by referring to FIG. 16. The double patterning refers to an exposure technique that divides a dense pattern into two low-density patterns which are then exposed separately. By combining the two patterns together a final pattern density can be enhanced. Denoted 1601-1 and 1601-2 are two SEM images including patterns formed by the double patterning. Reference numbers 1602-1 to 1602-4 represent design data of the patterns corresponding to 1601-1, 1601-2. Patterns 1603-1 to 1603-4 are formed by a first exposure and patterns 1604-1 to 1604-4 by a second exposure. In the double patterning operation, there may occur a positional shift between the first exposed patterns and the second exposed patterns depending on the position alignment accuracy of a projection aligner. The patterns 1603-1, 1603-2 represent an example case where they are shifted downward from the design data 1602-1, 1602-2. So, simply extracting pattern areas 1605-1 to 1605-4 having similar shapes will not result in the image restoration processing being completed as desired since there is a shift between the first exposed patterns and the second exposed patterns. To deal with this situation, this invention is characterized in that a resolution-enhanced image is generated for the first exposed patterns and for the second exposed patterns by performing the image restoration processing on the first exposed patterns and the second exposed patterns respectively. Denoted 1606-1 to 1606-4 are images of areas extracted from the input SEM image that include the first exposed patterns. Reference numbers 1607-1 to 1607-4 represent images of areas that include the second exposed patterns. Denoted 1608 is a high resolution image generated by the image restoration processing from the first exposed patterns 1606-1 to 1606-4; and 1609 denotes a high resolution image generated by the image restoration processing from the second exposed patterns 1607-1 to 1607-4. Reference number 1610 indicates a high resolution image of the area 1605-1 formed by combining the individual high resolution images 1608 and 1609.

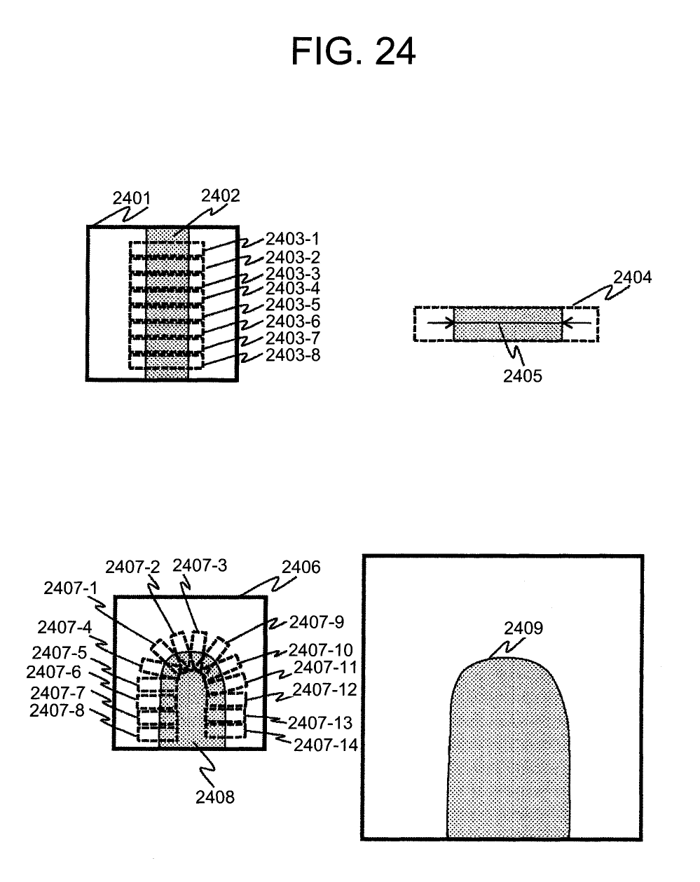

When a pattern dimension is measured by detecting edge positions through image processing, there is a case where an image profile of an area including and surrounding the pattern edges need only be enhanced in resolution. An example process of enhancing the image resolution of the pattern edges and their surrounding areas in the input image according to this invention will be explained by referring to FIG. 24. Denoted 2401 is an input SEM image that contains a line pattern 2402. Reference numerals 2403-1 to 2403-8 represent a group of similar areas so extracted as to include the edges of the line pattern 2402 and their surrounding areas. Using the group of similar areas 2403-1 to 2403-8 a resolution-enhanced image 2404 is obtained. With the high resolution line pattern image 2404, a line pattern dimension 2405 can be measured with high accuracy. It is also possible to enhance the image resolution of edges of any other desired pattern. One such example will be explained by referring to a SEM image 2406 of FIG. 24. Denoted 2408 is not a simple line pattern but a pattern including a curved edge. As shown at 2407-1 to 2407-14, the similar areas are extracted as areas extending perpendicular to the edge of the pattern. This extraction procedure allows a group of similar areas to be extracted from any pattern shape, which means that the image of an edge and its surrounding areas can be enhanced in resolution. Denoted 2409 is obtained by pasting the resolution-enhanced images of the edge and its surrounding areas to positions corresponding to the group of similar areas. Using the high resolution image 2409 the pattern dimension can be measured, or a pattern outline can also be extracted from 2409. As described above, by finely setting a group of similar areas, not only curved patterns but any shapes of pattern can be enhanced in resolution.

### Embodiment 6

An example embodiment in which the present invention is applied to a defect inspection will be explained by referring to FIG. 17. Denoted 1701 is an image to be inspected that has been imaged by a SEM (inspection image). Denoted 1702 is a reference image that has a similar appearance to 1701 but does not include any result. In a defect inspection, comparison between the inspection image 1701 and the reference image 1702 enables an area containing a defect portion (1704) to be extracted. The reference image may be acquired by imaging the same coordinates on an adjoining chip in the inspection image. Designated 1703 is a defect area extracted by the comparison. Denoted 1705 is a high resolution reference image which is generated, in areas where the image restoration processing is applicable, by extracting a plurality of areas having similar pattern shapes (similar areas), performing the image restoration processing on these extracted areas to generate resolution-enhanced images, and pasting the resolution-enhanced images to the corresponding similar areas. In areas where the image restoration processing is not applicable because there is no similar patterns, the high resolution reference image is produced by interpolating and extending pixel values of the inspection image 1701 and pasting the interpolated and extended image. By dividing the area to be processed into an area where the image restoration processing is applicable and an area where it is not, as described above, a high resolution reference image can also be produced even for an inspection image not made up of simple repetitive patterns. Further, by reducing the high resolution reference image to the same size as the inspection image, the reference image can also be used for comparison inspection. It is also possible to enhance the resolution of an entire inspection image that is generated, as shown at 1706, by interpolating and extending the inspection image corresponding to the defect areas 1703 and pasting the interpolated and extended inspection image to the high resolution reference image.

### Embodiment 7

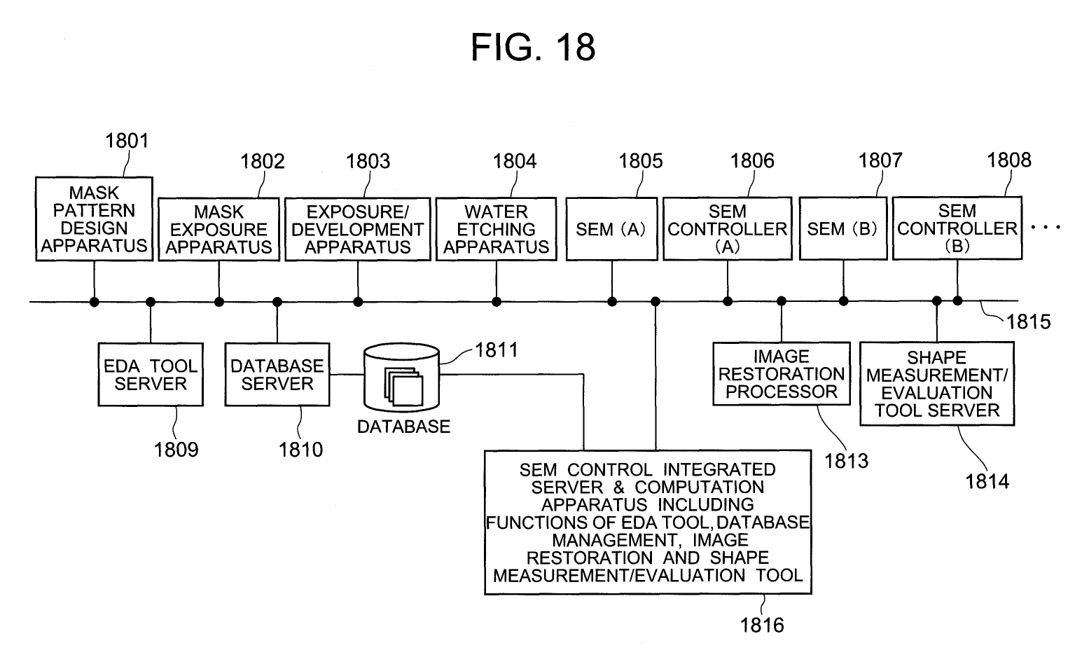

An example of system configuration of this invention will be explained by referring to FIG. 18. In FIG. 18, denoted 1801 is a mask pattern designing apparatus, 1802 a mask exposure apparatus, 1803 an exposure/development apparatus to expose a mask pattern on a wafer, 1804 a wafer etching apparatus, 1805 and 1807 SEM's, 1806 and 1808 SEM controllers, 1809 an EDA (Electronic Design Automation) tool server, 1810 a database server, 1811 a storage for storing the database, 1813 an image restoration processor, and 1814 a generated pattern shape measurement/evaluation tool server. These can transmit and receive information to and from one another through a network 1815. While in the figure two SEM's 1805 and 1807 are shown to be interconnected via the network, any number of SEM's may be used to photograph SEM images which are then stored in the database server 1811 for sharing. Apparatuses 1806, 1808, 1809, 1810 and 1812-1814 may be integrated in one apparatus 1816. As in this example, this invention allows any desired functions to be divided or integrated in any number of apparatuses for their execution.

### Embodiment 8

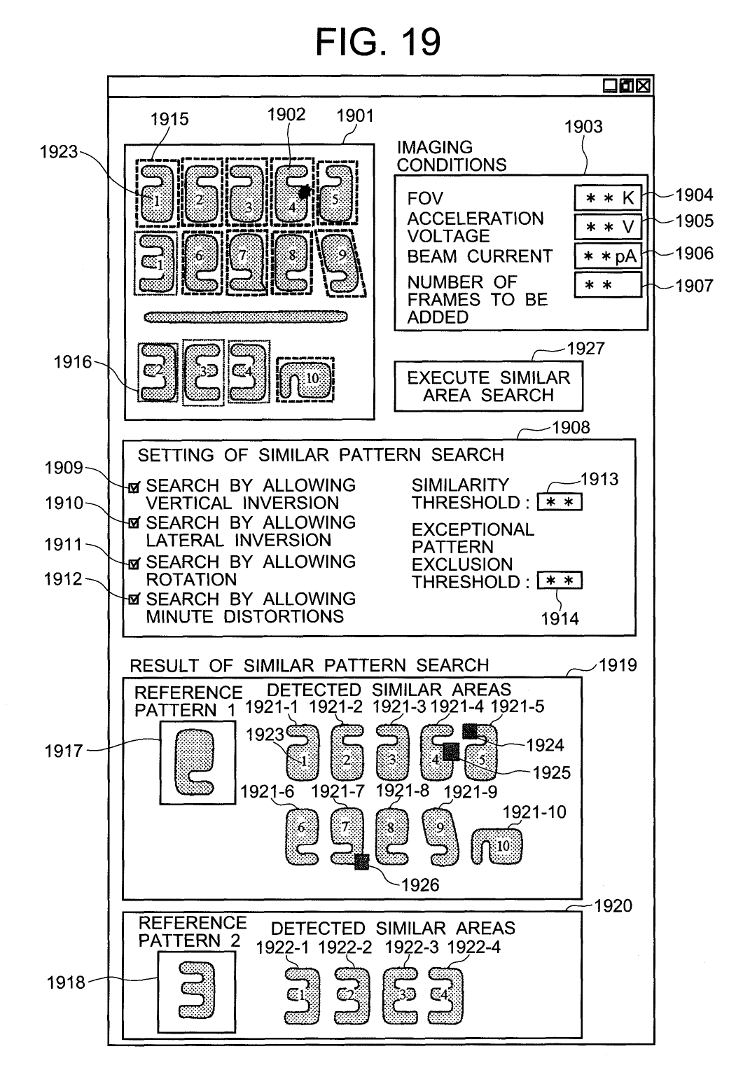

Examples of GUI for setting or displaying input/output information in this invention will be explained by referring to FIG. 19 to FIG. 21. Various sets of information shown in windows in FIG. 19 to FIG. 21 can be divided and displayed in any desired combination on a display. Marks ** in the figures represent any series of values (or character strings) or any desired range of values.

FIG. 19 is an example of GUI in which to make settings for the processing to enhance the resolution of an input SEM image. Denoted 1901 is a photographed SEM image and shaded areas 1902 in the SEM image 1901 represent wiring patterns. The SEM image 1901 is shot under conditions shown in a box 1903 (a field of view (FOV) 1904, an acceleration voltage 1905, a beam current 1906 and the number of frames to be added 1907). At this time, two or more SEM images may be take in or displayed on the GUI. In a box 1908 parameters used to extract patterns of similar shapes from the SEM image 1901 are set. Among items to be set here are whether or not vertical inversions of patterns are allowed in a search (1909), whether or nor lateral inversions of patterns are allowed in a search (1910), whether or not pattern rotations are allowed in a search (1911) and whether or not minute pattern distortions are allowed in a search (1912). The pattern rotation may be limited to 90°, 180° and 270° in a search or any desired angle of rotation may be used in the search. For minute distortions, a linear image transformation such as affine transformation, or a distortion model expressed by polynomials such as quadratic transformation may be used. Pressing a button 1927 initiates a search through the SEM image 1901 for areas having patterns of similar shapes (similar areas). A box 1913 is for setting a threshold of pattern similarity level in extracting a group of similar areas. A box 1915 and a box 1916 represent groups of extracted similar areas, each group being enclosed in a unique color box for identity of its kind. In this example, there are two patterns by which the image restoration processing is carried out (two reference patterns), shown at 1917 and 1918. The reference patterns may automatically be determined by searching areas that have two or more similar patterns. They may also be specified directly by the user on the GUI. Shown in each of boxes 1919, 1920 are images of similar areas (1921-1 to 1921-10, 1922-1 to 1922-4) in each group extracted for each of reference patterns 1917, 1918. The extracted similar areas in each group may be assigned serial numbers to show their correspondence to the patterns on the input SEM image (as at 1923). Denoted 1924-1926 are the result of extracting areas of defects on these patterns. The areas of defects can be extracted by performing the threshold processing on image differences between the images of similar areas and the reference pattern or an average image of the similar areas. The threshold for the extraction of defects can be set in a box 1914.

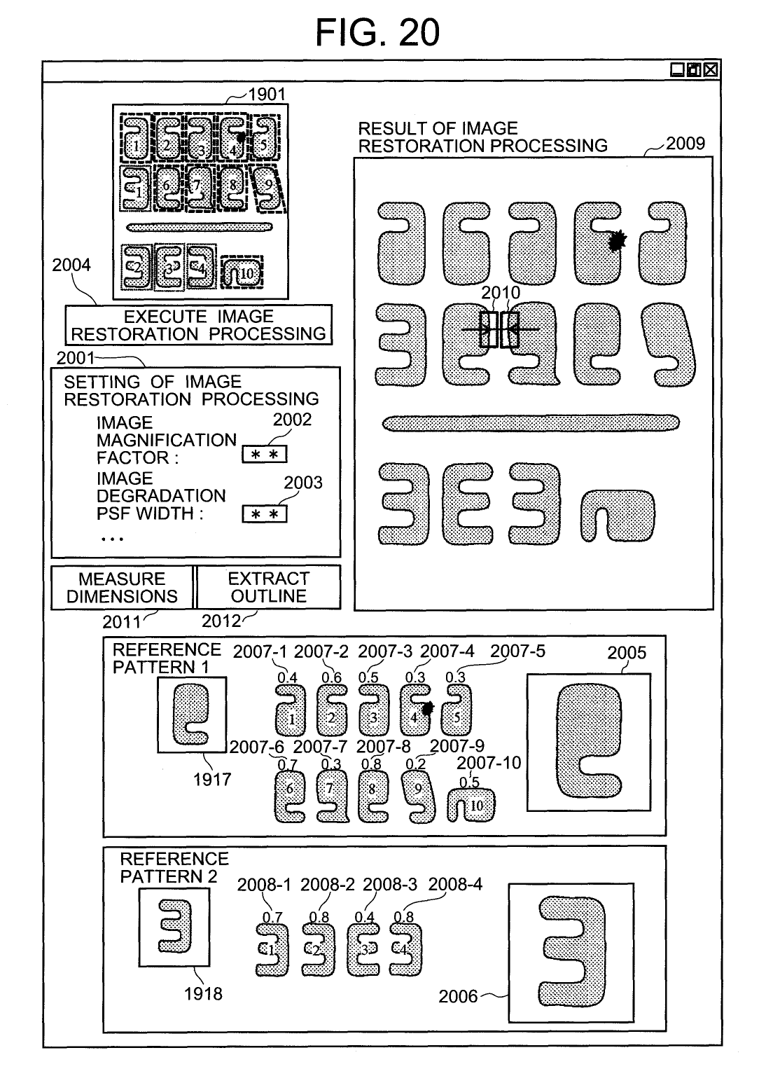

FIG. 20 is an example of GUI in which to set parameters for the image restoration processing. Denoted 1901 is an input SEM image. This GUI also displays reference patterns 1917, 1918 and groups of similar areas corresponding to these reference patterns, as in FIG. 19. A box 2001 is used to set parameters for the image restoration processing. For example, a box 2002 is used to set an image magnification factor and a box 2003 to set parameters for a degraded model of an image shot by a SEM (e.g., model parameter values for a point spread function, such as beam diameter of the SEM). Pressing a button 2004 causes the image restoration processing to be initiated according to parameters set in the box 2001. Designated 2005 and 2006 are resolution-enhanced images obtained by performing the image restoration processing on the reference patterns 1917 and 1918, respectively. The image restoration processing can be executed either by evaluating and displaying the similarity level for each of the similar areas (2007-1 to 2007-10, 2008-1 to 2008-4) or by using the similarity level as a weight. The similarity level may be calculated automatically from the images or manually set. It is also possible to display in a box 2009 a result of pasting the high resolution images at positions where the similar areas are. For areas that have failed to be enhanced in resolution by the image restoration processing (e.g., areas having only one similar shape pattern or defect areas), their images may simply be interpolated and extended and then pasted to where the original areas are, in order to virtually enhance the resolution of the entire input image.

Further, the resolution-enhanced images may be processed to measure pattern dimensions or extract their outlines. In taking measurements of pattern dimensions, measurement boxes shown at 2010 are specified and a button 2011 is pressed to measured the specified pattern width, gap and pitch. Similarly, pressing a button 2012 causes the outline of the entire input image or of a specified pattern to be extracted. These pattern shape evaluations can be applied to the resolution-enhanced input image as a whole or to images 2005, 2006, which are enhanced in resolution from the reference patterns.

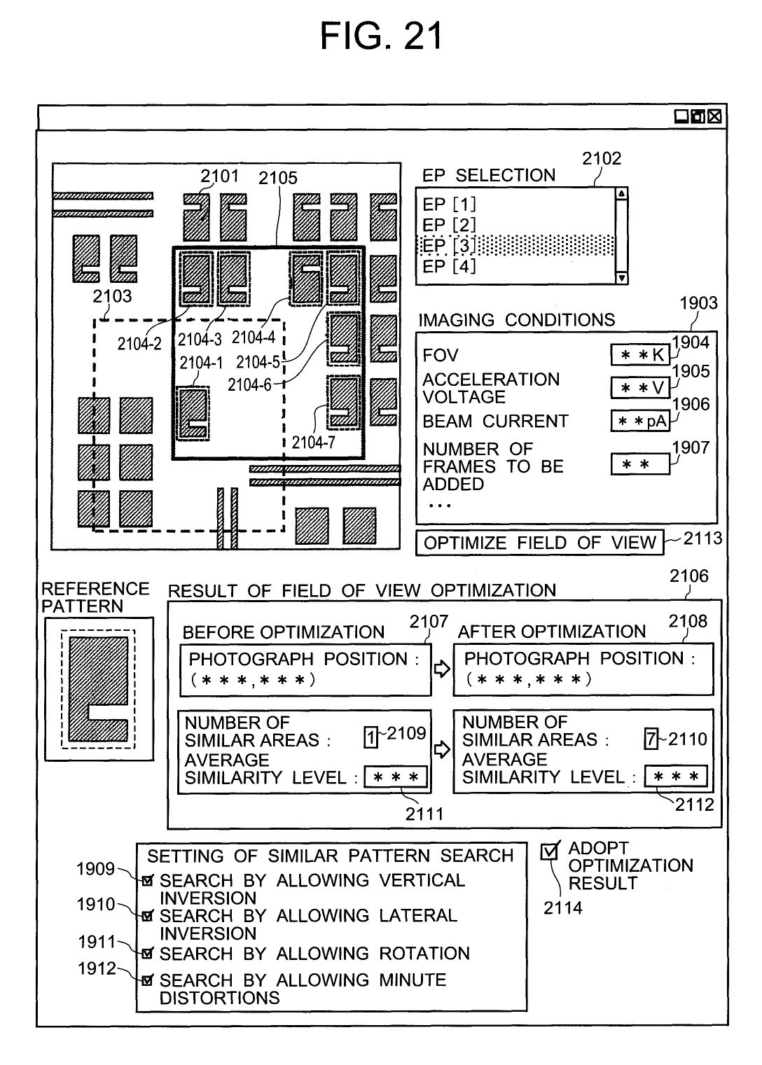

FIG. 21 shows an example of GUI in which to make settings for the image restoration processing that uses design data. Shaded areas 2101 represent patterns of design data taken in. Desired processing can be set for individual pattern areas to be evaluated by picking up their coordinates (evaluation points: EP) from a list 2102. The evaluation point may be given by the user or taken from hotspots output from an EDA tool where a defect is considered likely to occur. A box 1903 is used to set SEM imaging conditions (a field of view 1904, an acceleration voltage 1905, a beam current 1906 and the number of frames to be added 1907). Denoted 2103 is a field of view with its center at an EP coordinate value. Denoted 2104-1 is a pattern whose shape is to be evaluated (reference pattern). The reference pattern may be provided by the user or extracted from design data patterns in the neighborhood of the EP coordinate value. Pressing a button 2113 initiates the imaging position optimization. 2104-2 to 2104-7 represent a result of extracting from design data those patterns similar to the reference pattern 2104-1. 2105 represents a field of view optimized to include as many design data patterns, which are similar to the reference pattern, as possible. A box 2106 shows imaging positions 2107-2108 before and after the optimization of the field of view, the number of areas of patterns 2109, 2110 similar in shape to the reference pattern 2104-1, and an average similarity levels 2111, 2112 for the extracted groups of similar areas. In the search for similar patterns, as in FIG. 19, whether or not to allow vertical and lateral inversions, rotations or minute distortions of patterns can be specified (1909-1912). It is also possible to specify in a check box 2114 whether or not to adopt the optimized field of view.

While the present invention has been described in detail by way of examples, it should be noted, however, that the invention is in no way limited to these examples but that various modifications may be made without departing from the spirit of the invention. That is, although a SEM has been described as an example case, the invention can also be applied to other scanning charged particle microscopes, such as scanning ion microscope (SIM) or scanning transmission electron microscope (STEM). Further, although above embodiments have been described under different sections, they do not have to be implemented independent of each other but the contents described in different embodiments may be combined as required.

Representative features and advantages of the invention disclosed in this application are briefly explained as follows. With this invention, a high resolution image can be obtained while at the same time minimizing damages to samples caused by electron beams during the process of imaging by a scanning charged particle microscope. This makes it possible to acquire a high resolution SEM image of even a sample that has low resistance against electron beams, such as resist patterns, allowing for a highly precise shape evaluation of patterns. Based on this shape evaluation, correct decisions can be made in the optimization of the semiconductor manufacturing process and in the design of photomask patterns.

### REFERENCE SIGNS LIST

101 . . . semiconductor wafer, 102 . . . electro-optical system, 103 . . . electron gun, 104 . . . electron beam (primary electrons), 105 . . . condenser lens, 106 . . . deflector, 107 . . . ExB deflector, 108 . . . objective lens, 109 . . . secondary electron detector, 110, 111 . . . backscattered electron detectors, 112-114 . . . A/D converters, 115 . . . processing and control unit, 116 . . . CPU, 117 . . . image memory, 118 . . . database (storage), 119 . . . image restoration processor, 120 . . . shape measurement/evaluation tool server, 121 . . . stage, 122, 123 . . . processing terminals, 301, 309 . . . input SEM images, 302-1 to 302-15 . . . patterns, 303 . . . particle, 304, 305 . . . pattern defects, 306 . . . area where image restoration processing can be performed, 307-1 to 307-10 . . . group of areas having similar patterns, 308-1 to 308-4 . . . group of areas having similar patterns, 401-403 . . . areas containing defects, 404-1 to 404-1, 405-1 to 405-4 . . . groups of areas having similar patterns, 406, 407 . . . images produced by enhancing resolution of a part of input image by image restoration processing, 408 . . . image produced by enhancing resolution of an entire input image, 409-1 to 409-4 . . . result of pasting images produced by enhancing resolution of a part of input image by image restoration processing, 501 . . . input SEM image, 502-1 to 502-4 . . . patterns, 503-1 to 503-4 . . . group of areas having similar patterns, 504-1 to 504-4 . . . pattern similarity levels of areas with 503-1 taken as a reference, 505-1 to 505-4 . . . pattern similarity levels of areas with 503-3 taken as a reference, 506 . . . result of enhancing resolution of an entire input image, 507 . . . image produced by enhancing resolution of an image by image restoration processing, 508 . . . result of changing parameters of image restoration processing for each area and enhancing resolution of an entire input image, 509-1 to 509-4 . . . images produced by enhancing resolution of each area, 510 . . . calculated similarity indices with 503-1 taken as a reference, 511 . . . calculated similarity indices with 503-3 taken as a reference, 601 . . . dimension of resolution-enhanced pattern image, 602 . . . outline of resolution-enhanced pattern image, 603 . . . dimension between resolution-enhanced patterns, 1001 . . . field of view, 1002 . . . design pattern, 1003-1 to 1003-10 . . . group of areas having similar patterns, 1101 . . . design pattern, 1102-1 to 1102-3 . . . field of view, 1103-1 to 1103-9 . . . group of areas having similar patterns, 1201 . . . input SEM image, 1202-1 to 1202-7 . . . design patterns, 1203-1 to 1203-7 . . . circuit patterns on SEM image, 1204 . . . particle, 1205, 1206 . . . pattern defects, 1207-1 to 1207-6 . . . group of areas having similar patterns, 1301 . . . input SEM image, 1302-1 to 1302-12 . . . group of areas having similar patterns, 1303 . . . resolution-enhanced line pattern, 1304 . . . dimension of line pattern, 13051, 1306 . . . image processing areas in which to detect line edge positions (measurement boxes), 1307-1, 1307-2 . . . line patterns whose widths differ from those of central line patterns in input image, 1400 . . . input SEM image, 1401-1 to 1401-16 . . . group of areas having hole patterns, 1402 . . . resolution-enhanced hole pattern image, 1403 . . . hole pattern diameter measurement, 1404-1 to 1404-4 . . . group of resolution-enhanced hole pattern images, 1405-1 to 1405-4 . . . group of hole pattern diameter measurements, 1501 . . . mask pattern with OPC, 1502-1 to 1502-4 . . . group of input SEM images, 1503 . . . result of enhancing resolution of group of input SEM images, 1504 . . . mask pattern outline extracted from resolution-enhanced image, 1505 . . . shape of mask pattern design data, 1601-1, 1601-2 . . . input SEM images, 1602-1, 1602-2 . . . shapes of design data patterns for first exposure, 1602-3, 1602-4 . . . shapes of design data patterns for second exposure, 1603-1 to 1603-4 . . . patterns formed by first exposure, 1604-1 to 1604-4 . . . patterns formed by second exposure, 1605-1 to 1605-4 . . . group of areas having similar patterns, 1606-1 to 1606-4 . . . group of areas having similar patterns formed by first exposure, 1607-1 to 1607-4 . . . group of areas having similar patterns formed by second exposure, 1608 . . . resolution-enhanced image produced from patterns formed by first exposure, 1609 . . . resolution-enhanced image produced from patterns formed by second exposure, 1610 . . . resolution-enhanced image produced from patterns formed by first and second exposure, 1701 . . . inspection image, 1702. reference image, 1703 . . . area including defect, 1705 . . . resolution-enhanced reference image, 1706 . . . resolution enhanced inspection image, 1801 . . . mask pattern designing apparatus, 1802 . . . mask exposure apparatus, 1803 . . . exposure/development apparatus, 1804 . . . wafer etching apparatus, 1806, 1807 . . . SEM's, 1806, 1808 . . . SEM controllers, 1809 . . . EDA tool server, 1810 . . . database server, 1811 . . . database, 1812 . . . imaging recipe generation apparatus, 1813 . . . image restoration processing apparatus, 1814 . . . shape measurement/evaluation tool server, 1815 . . . network, 1815 . . . SEM control integrated server & computation apparatus including functions of EDA tool, database management, imaging recipe generation, image restoration processing and shape measurement/evaluation tool, 1901 . . . input SEM image, 1902 . . . patterns, 1903 . . . SEM imaging condition setting box, 1904 . . . imaging range setting box, 1905 . . . acceleration voltage setting box, 1906 . . . beam current setting box, 1907 . . . frame number setting box, 1908 . . . similar pattern search setting box, 1909 . . . check box on whether or not to allow vertical inversion in similar pattern search, 1910 . . . check box on whether or not to allow lateral inversion in similar pattern search, 1911 . . . check box on whether or not to allow rotation in similar pattern search, 1912 . . . check box on whether or not to allow minute distortions in similar pattern search, 1913 . . . similar pattern decision threshold setting box, 1914 . . . exceptional pattern detection threshold setting box, 1915, 1916 . . . areas having similar patterns, 1917, 1918 . . . unit pattern for executing image restoration processing (reference pattern), 1919, 1920 . . . boxes showing groups of similar areas for reference patterns, 1921-1 to 1921-10, 1922-1 to 1922-4 . . . groups of areas having similar patterns, 1923 . . . serial number of similar areas, 1924 to 1926 . . . exceptional areas, 1927 . . . similar area search execution button, 2001 . . . image restoration processing setting box, 2002 . . . image magnification factor setting box, 2003 . . . image degradation model parameter input box, 2004 . . . image restoration processing execution button, 2005, 2006 . . . result of image restoration processing, 2007-1 to 2007-10, 2008-1 to 2008-4 . . . similarity levels of patterns in similar areas, 2009 . . . result of enhancing resolution of entire input SEM image, 2010 . . . measurement box, 2011 . . . dimension measurement execution button, 2012 . . . outline extraction execution button, 2101 . . . design patterns, 2102 . . . EP selection list box, 2103 . . . first field of view, 2104-1 to 2104-7 . . . group of similar areas, 2105 . . . second field of view determined by optimization, 2106 . . . box in which to show optimized field of view, 2107 . . . imaging position before optimization, 2108 . . . imaging position after optimization, 2109 . . . the number of similar areas included in pre-optimization field of view, 2110 . . . the number of similar areas included in post-optimization field of view, 2111 . . . average similarity level of similar areas before optimization, 2112 . . . average similarity level of similar areas after optimization, 2113 . . . field of view optimization execution button, 2114 . . . check box on whether or not to adopt optimized field of view, 2201 . . . patterns, 2202-1 to 2202-3 . . . first group of similar areas, 2203-1 to 2203-3 . . . second group of similar areas, 2204-1 to 2204-3 . . . group of similar areas of arbitrary shape, 2205 . . . pattern, 2401 . . . input SEM image, 2402 . . . line pattern, 2403-1 to 2403-8 . . . group of similar areas, 2404 . . . resolution enhanced line pattern, 2405 . . . dimension of line pattern, 2406 . . . input SEM image, 2407 . . . line end pattern, 2408-1 to 2408-14 . . . group of similar areas, 2409 . . . resolution-enhanced pattern.

1. A method of observing a sample formed with circuit patterns by using a scanning charged particle microscope, the sample observing method comprising the steps of:
acquiring an input image by imaging the circuit patterns using the scanning charged particle microscope;
extracting from the acquired single input image a plurality of areas having patterns similar in shape to one another, based on a predetermined decision criterion;
generating from images of the plurality of the extracted areas having patterns similar in shape to one another an image higher in resolution than the images of the plurality of the extracted areas; and
observing the circuit patterns by using the generated image higher in resolution than the images of the plurality of the extracted areas.

2. A sample observation method according to claim 1, wherein the step of extracting a plurality of areas checks indices of how many areas containing patterns similar in shape to one another can be extracted from the single input image and of how much the images of the extractable areas containing similar patterns resemble each other, and extracts the plurality of areas based on the indices.

3. A sample observation method according to claim 1, wherein, before extracting a plurality of areas according to the predetermined decision criterion, the step of extracting a plurality of areas determines in the input image a similar pattern categorized region having at least two patterns similar in shape and extracts the plurality of areas according to the predetermined decision criterion from the similar pattern categorized region.

4. A sample observation method according to claim 1, wherein the step of observing the circuit patterns pastes the generated image higher in resolution than the images of the plurality of the extracted areas to where the plurality of the extracted areas are in the input image, and observes the circuit patterns using the pasted images.

5. A sample observation method according to claim 1, wherein the step of generating an image higher in resolution than the images of the plurality of the extracted areas takes a weighted mean of the images of the plurality of the extracted areas to generate the single image.

6. A sample observation method according to claim 4, wherein the step of generating an image higher in resolution than the images of the plurality of the extracted areas produces the same number of images higher in resolution than the plurality of the extracted areas as the number of the extracted areas;
wherein a similarity index value of each of the plurality of the images higher in resolution than the images of the plurality of the extracted areas corresponds to a similarity index value of each of the images of the plurality of the extracted areas.

7. A sample observation method according to claim 1, wherein the step of extracting a plurality of areas extracts areas containing patterns similar to a pattern of interest contained in an area specified by the user.

8. A sample observation method according to claim 7, wherein the step of generating an image higher in resolution than the images of the plurality of the extracted areas generates an image of the pattern of interest with a higher resolution than those of the images of the plurality of the extracted areas as an image higher in resolution than the images of the plurality of the extracted areas;
wherein the step of observing the circuit patterns uses the image of the pattern of interest with a higher resolution than those of the images of the plurality of the extracted areas to measure dimensions of the pattern of interest.

9. A sample observation method according to claim 7, wherein the step of generating an image higher in resolution than the images of the plurality of the extracted areas generates an image of the pattern of interest with a higher resolution than those of the images of the plurality of the extracted areas as an image higher in resolution than the images of the plurality of the extracted areas;
wherein the step of observing the circuit patterns uses the image of the pattern of interest with a higher resolution than those of the images of the plurality of the extracted areas to extract an outline of the pattern of interest.

10. A sample observation method according to claim 1, further comprising the steps of: before acquiring the input image, setting an imaging field of view photographed by the scanning charged particle microscope and then reading design data present in a field of view including at least the imaging field of view thus set;
wherein the step of acquiring the input image acquires the input image by photographing the imaging field of view by the scanning charged particle microscope;
wherein the step of extracting a plurality of areas extracts the plurality of areas from the input image according to the design data.

11. A sample observation method according to claim 10, wherein the step of extracting a plurality of areas checks an index of how many areas containing patterns similar in shape to one another can be extracted from the input image and of how much the images of the extractable areas containing similar patterns resemble each other, and extracts the plurality of areas from the design data according to the index.

12. A sample observation method according to claim 1, wherein the patterns similar in shape to one another include those which resemble one another if they undergo a vertical or lateral inversion, a rotation through about 90 degrees or a correction of distortion in an inclined direction.

13. A device for observing a sample formed with circuit patterns comprising:
a scanning charged particle microscope to acquire an input image by imaging the circuit patterns;
a means to extract from the acquired single input image a plurality of areas having patterns similar in shape to one another, based on a predetermined decision criterion;
a means to generate from images of the plurality of the extracted areas having patterns similar in shape to one another an image higher in resolution than the images of the plurality of the extracted areas; and
a means to observe the circuit patterns by using the generated images higher in resolution than the images of the plurality of the extracted areas.

14. A sample observing device according to claim 13, further comprising:
a display means to display both the images of the plurality of the extracted areas having patterns similar in shape to one another and the image higher in resolution than the images of the plurality of the extracted areas.

15. A method for generating an image of semiconductor circuit patterns formed on a sample by using a scanning charged particle microscope, the image generation method comprising:
an image input step to take in an image acquired by imaging the semiconductor circuit patterns using the scanning charged particle microscope (input image);
a similar region categorizing step to identify in the input image a region having at least two similarly shaped patterns (similar pattern categorized region) and a region with no such patterns (non-similar pattern categorized region);
a similar area group determination step to determine in the similar pattern categorized region a group of areas used for image restoration processing (a group of similar areas); and
a high resolution image generation step to produce a single resolution-enhanced image of a similar area (high resolution image) from images of the group of similar areas by the image restoration processing;
wherein each of the similar areas in the group includes a similarly shaped common pattern;
wherein the similar areas are determined based on an index value (similarity index value) representing the number of the similar areas in the group and the similarity levels between images of the similar areas in the group.

16. An image generation method according to claim 15, wherein, in the similar area group determination step, if an image of one of the similar areas in the group, or a first similar area, after being rotated, inverted or subjected to minute deformations, resembles an image of another similar area in the group, or a second similar area, the similarity index value between the first similar area image and the second similar area image is set high.

17. A device for generating an image of semiconductor circuit patterns formed on a sample by using a scanning charged particle microscope, the image generation method comprising:
an image input means to take in an image (input image) acquired by imaging the semiconductor circuit patterns using the scanning charged particle microscope;
a similar region categorizing means to identify from within the input image a region having at least two similarly shaped patterns (similar pattern categorized region) and a region with no such patterns (non-similar pattern categorized region);
a similar area group determination means to determine from within the similar pattern categorized region a group of areas used for image restoration processing (a group of similar areas); and
a high resolution image generation means to produce a single resolution-enhanced image of similar areas (high resolution image) from the images of the group of similar areas by the image restoration processing;
wherein each of the similar areas in the group includes a similarly shaped common pattern;
wherein the similar areas are determined based on an index value (similarity index value) representing the number of the similar areas in the group and the similarity levels between images of the similar areas in the group.
